(19) United States
(12) Patent Application Publication
(10) Pub. No.: US 2025/0311021 A1
(43) Pub. Date: Oct. 2, 2025

(54) TECHNIQUES FOR A CONFIGURATION OF PROTOCOL DATA UNIT (PDU) SET IMPORTANCE (PSI) FIELD SEMANTICS AND QUALITY OF SERVICE (QOS) PROVISIONING

(71) Applicant: QUALCOMM Incorporated, San Diego, CA (US)

(72) Inventors: Liangping MA, San Diego, CA (US); Sitaramanjaneyulu KANAMARLAPUDI, San Diego, CA (US); Prashanth Haridas HANDE, San Diego, CA (US)

(21) Appl. No.: 19/090,943

(22) Filed: Mar. 26, 2025

Related U.S. Application Data
(60) Provisional application No. 63/572,894, filed on Apr. 1, 2024.

(51) Int. Cl. H04W 76/10; H04W 28/02; H04W 76/20

(52) U.S. Cl. CPC H04W 76/10; H04W 28/0268; H04W 76/20

(57) ABSTRACT

Methods, systems, and devices for media session management are described. In some aspects, two or more of various devices or entities may support one or more signaling- or configuration-based mechanisms according to which such devices or entities may communicate information associated with an interpretation of a protocol data unit (PDU) set importance (PSI) field of a PDU header. In accordance with communicating the information associated with the interpretation of the PSI field, a device or entity may communicate one or more PDUs (or may otherwise perform communication associated with one or more PDUs, such as communication associated with providing, encapsulating, relaying, or configuring a resource allocation for the one or more PDUs) in accordance with the interpretation. The indicated interpretation may define, specify, or indicate how a device or entity is to treat, parse, allocate, or otherwise communicate (e.g., transmit or receive) PDU sets conveying a given PSI field value.

### CROSS REFERENCE

This patent application claims the benefit of U.S. Provisional Patent Application No. 63/572,894 by Ma et al., entitled “TECHNIQUES FOR A CONFIGURATION OF PROTOCOL DATA UNIT (PDU) SET IMPORTANCE (PSI) FIELD SEMANTICS AND QUALITY OF SERVICE (QOS) PROVISIONING,” filed Apr. 1, 2024, which is assigned to the assignee hereof and expressly incorporated in its entirety herein.

### FIELD OF TECHNOLOGY

The following relates to media session management, including techniques for a configuration of protocol data unit (PDU) set importance (PSI) field semantics and quality of service (QOS) provisioning.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for media session management by a first device is described. The method may include establishing a protocol data unit (PDU) session between the first device and a second device in accordance with an application at the first device, communicating, in association with establishing the PDU session, a first communication of information associated with an interpretation of a PDU set importance (PSI) field of a PDU header, and communicating a second communication of one or more PDUs of one or more PDU sets associated with the application in accordance with the interpretation of the PSI field.

A first device for media session management is described. The first device may include one or more memories storing processor executable code, and one or more processors coupled with the one or more memories. The one or more processors may individually or collectively be operable to execute the code to cause the first device to establish a PDU session between the first device and a second device in accordance with an application at the first device, communicate, in association with establishing the PDU session, a first communication of information associated with an interpretation of a PSI field of a PDU header, and communicate a second communication of one or more PDUs of one or more PDU sets associated with the application in accordance with the interpretation of the PSI field.

Another first device for media session management is described. The first device may include means for establishing a PDU session between the first device and a second device in accordance with an application at the first device, means for communicating, in association with establishing the PDU session, a first communication of information associated with an interpretation of a PSI field of a PDU header, and means for communicating a second communication of one or more PDUs of one or more PDU sets associated with the application in accordance with the interpretation of the PSI field.

A non-transitory computer-readable medium storing code for media session management is described. The code may include instructions executable by one or more processors to establish a PDU session between the first device and a second device in accordance with an application at the first device, communicate, in association with establishing the PDU session, a first communication of information associated with an interpretation of a PSI field of a PDU header, and communicate a second communication of one or more PDUs of one or more PDU sets associated with the application in accordance with the interpretation of the PSI field.

A method for media session management by a first device is described. The method may include establishing a PDU session between the first device and a second device in accordance with an application at the first device, selecting a set of communication parameters for one or more PDUs associated with the application in accordance with a media type associated with the one or more PDUs, and transmitting the one or more PDUs in accordance with the set of communication parameters.

A first device for media session management is described. The first device may include one or more memories storing processor executable code, and one or more processors coupled with the one or more memories. The one or more processors may individually or collectively be operable to execute the code to cause the first device to establish a PDU session between the first device and a second device in accordance with an application at the first device, select a set of communication parameters for one or more PDUs associated with the application in accordance with a media type associated with the one or more PDUs, and transmit the one or more PDUs in accordance with the set of communication parameters.

Another first device for media session management is described. The first device may include means for establishing a PDU session between the first device and a second device in accordance with an application at the first device, means for selecting a set of communication parameters for one or more PDUs associated with the application in accordance with a media type associated with the one or more PDUs, and means for transmitting the one or more PDUs in accordance with the set of communication parameters.

A non-transitory computer-readable medium storing code for media session management is described. The code may include instructions executable by one or more processors to establish a PDU session between the first device and a second device in accordance with an application at the first device, select a set of communication parameters for one or more PDUs associated with the application in accordance with a media type associated with the one or more PDUs, and transmit the one or more PDUs in accordance with the set of communication parameters.

A method for media session management by a first device is described. The method may include establishing a PDU session between the first device and a second device in accordance with an application at the first device, receiving, in association with establishing the PDU session, information associated with a mapping between each PDU set of a set of multiple PDU sets and a respective set of communication parameters, selecting, in accordance with the mapping, a first set of communication parameters for a first PDU set associated with the application and a second set of communication parameters for a second PDU set associated with the application, where the first PDU set and the second PDU set are associated with a same quality of service (QoS) flow, transmitting the first PDU set in accordance with the first set of communication parameters, and transmitting the second PDU set in accordance with the second set of communication parameters.

A first device for media session management is described. The first device may include one or more memories storing processor executable code, and one or more processors coupled with the one or more memories. The one or more processors may individually or collectively be operable to execute the code to cause the first device to establish a PDU session between the first device and a second device in accordance with an application at the first device, receive, in association with establishing the PDU session, information associated with a mapping between each PDU set of a set of multiple PDU sets and a respective set of communication parameters, select, in accordance with the mapping, a first set of communication parameters for a first PDU set associated with the application and a second set of communication parameters for a second PDU set associated with the application, where the first PDU set and the second PDU set are associated with a same QoS flow, transmit the first PDU set in accordance with the first set of communication parameters, and transmit the second PDU set in accordance with the second set of communication parameters.

Another first device for media session management is described. The first device may include means for establishing a PDU session between the first device and a second device in accordance with an application at the first device, means for receiving, in association with establishing the PDU session, information associated with a mapping between each PDU set of a set of multiple PDU sets and a respective set of communication parameters, means for selecting, in accordance with the mapping, a first set of communication parameters for a first PDU set associated with the application and a second set of communication parameters for a second PDU set associated with the application, where the first PDU set and the second PDU set are associated with a same QoS flow, means for transmitting the first PDU set in accordance with the first set of communication parameters, and means for transmitting the second PDU set in accordance with the second set of communication parameters.

A non-transitory computer-readable medium storing code for media session management is described. The code may include instructions executable by one or more processors to establish a PDU session between the first device and a second device in accordance with an application at the first device, receive, in association with establishing the PDU session, information associated with a mapping between each PDU set of a set of multiple PDU sets and a respective set of communication parameters, select, in accordance with the mapping, a first set of communication parameters for a first PDU set associated with the application and a second set of communication parameters for a second PDU set associated with the application, where the first PDU set and the second PDU set are associated with a same QoS flow, transmit the first PDU set in accordance with the first set of communication parameters, and transmit the second PDU set in accordance with the second set of communication parameters.

A method for media session management by a network entity is described. The method may include communicating, in association with an establishment of a PDU session between a first device and a second device, a first communication of information associated with an interpretation of a PSI field of a PDU header of PDUs communicated between the first device and the second device and communicating a second communication associated with providing one or more PDUs of one or more PDU sets from the first device to the second device in accordance with the interpretation of the PSI field.

A network entity for media session management is described. The network entity may include one or more memories storing processor executable code, and one or more processors coupled with the one or more memories. The one or more processors may individually or collectively be operable to execute the code to cause the network entity to communicate, in association with an establishment of a PDU session between a first device and a second device, a first communication of information associated with an interpretation of a PSI field of a PDU header of PDUs communicated between the first device and the second device and communicate a second communication associated with providing one or more PDUs of one or more PDU sets from the first device to the second device in accordance with the interpretation of the PSI field.

Another network entity for media session management is described. The network entity may include means for communicating, in association with an establishment of a PDU session between a first device and a second device, a first communication of information associated with an interpretation of a PSI field of a PDU header of PDUs communicated between the first device and the second device and means for communicating a second communication associated with providing one or more PDUs of one or more PDU sets from the first device to the second device in accordance with the interpretation of the PSI field.

A non-transitory computer-readable medium storing code for media session management is described. The code may include instructions executable by one or more processors to communicate, in association with an establishment of a PDU session between a first device and a second device, a first communication of information associated with an interpretation of a PSI field of a PDU header of PDUs communicated between the first device and the second device and communicate a second communication associated with providing one or more PDUs of one or more PDU sets from the first device to the second device in accordance with the interpretation of the PSI field.

A method for media session management by a network entity is described. The method may include obtaining one or more PDUs in association with a PDU session between a first device and a second device, selecting a set of communication parameters for one or more PDUs associated in accordance with a media type associated with the one or more PDUs, and transmitting the one or more PDUs in accordance with the set of communication parameters.

A network entity for media session management is described. The network entity may include one or more memories storing processor executable code, and one or more processors coupled with the one or more memories. The one or more processors may individually or collectively be operable to execute the code to cause the network entity to obtain one or more PDUs in association with a PDU session between a first device and a second device, select a set of communication parameters for one or more PDUs associated in accordance with a media type associated with the one or more PDUs, and transmit the one or more PDUs in accordance with the set of communication parameters.

Another network entity for media session management is described. The network entity may include means for obtaining one or more PDUs in association with a PDU session between a first device and a second device, means for selecting a set of communication parameters for one or more PDUs associated in accordance with a media type associated with the one or more PDUs, and means for transmitting the one or more PDUs in accordance with the set of communication parameters.

A non-transitory computer-readable medium storing code for media session management is described. The code may include instructions executable by one or more processors to obtain one or more PDUs in association with a PDU session between a first device and a second device, select a set of communication parameters for one or more PDUs associated in accordance with a media type associated with the one or more PDUs, and transmit the one or more PDUs in accordance with the set of communication parameters.

A method for media session management by a network entity is described. The method may include transmitting, in association with an establishment of a PDU session between a first device and a second device, information associated with a mapping between each protocol PDU set of a set of multiple PDU sets and a respective set of communication parameters, obtaining a first PDU set and a second PDU set in accordance with the PDU session between the first device and the second device, where the first PDU set and the second PDU set are associated with a same QoS flow, transmitting the first PDU set in accordance with a first set of communication parameters mapped to the first PDU set, and transmitting the second PDU set in accordance with a second set of communication parameters mapped to the second PDU set.

A network entity for media session management is described. The network entity may include one or more memories storing processor executable code, and one or more processors coupled with the one or more memories. The one or more processors may individually or collectively be operable to execute the code to cause the network entity to transmit, in association with an establishment of a PDU session between a first device and a second device, information associated with a mapping between each protocol PDU set of a set of multiple PDU sets and a respective set of communication parameters, obtain a first PDU set and a second PDU set in accordance with the PDU session between the first device and the second device, where the first PDU set and the second PDU set are associated with a same QoS flow, transmit the first PDU set in accordance with a first set of communication parameters mapped to the first PDU set, and transmit the second PDU set in accordance with a second set of communication parameters mapped to the second PDU set.

Another network entity for media session management is described. The network entity may include means for transmitting, in association with an establishment of a PDU session between a first device and a second device, information associated with a mapping between each protocol PDU set of a set of multiple PDU sets and a respective set of communication parameters, means for obtaining a first PDU set and a second PDU set in accordance with the PDU session between the first device and the second device, where the first PDU set and the second PDU set are associated with a same QoS flow, means for transmitting the first PDU set in accordance with a first set of communication parameters mapped to the first PDU set, and means for transmitting the second PDU set in accordance with a second set of communication parameters mapped to the second PDU set.

A non-transitory computer-readable medium storing code for media session management is described. The code may include instructions executable by one or more processors to transmit, in association with an establishment of a PDU session between a first device and a second device, information associated with a mapping between each protocol PDU set of a set of multiple PDU sets and a respective set of communication parameters, obtain a first PDU set and a second PDU set in accordance with the PDU session between the first device and the second device, where the first PDU set and the second PDU set are associated with a same QoS flow, transmit the first PDU set in accordance with a first set of communication parameters mapped to the first PDU set, and transmit the second PDU set in accordance with a second set of communication parameters mapped to the second PDU set.

Details of one or more implementations of the subject matter described in this disclosure are set forth in the accompanying drawings and the description below. Other features, aspects, and implementations will become apparent from the description, the drawings and the claims. Note that the relative dimensions of the following figures may not be drawn to scale.

### BRIEF DESCRIPTION OF THE DRAWINGS

FIG. 1 shows an example of a wireless communications system that supports techniques for a configuration of protocol data unit (PDU) set importance (PSI) field semantics and quality of service (QOS) provisioning in accordance with one or more aspects of the present disclosure.

FIG. 2 shows an example of a network architecture that supports techniques for a configuration of PSI field semantics and QoS provisioning in accordance with one or more aspects of the present disclosure.

FIG. 3 shows an example of a signaling diagram that supports techniques for a configuration of PSI field semantics and QoS provisioning in accordance with one or more aspects of the present disclosure.

FIGS. 4 and 5 show examples of process flows that support techniques for a configuration of PSI field semantics and QoS provisioning in accordance with one or more aspects of the present disclosure.

FIGS. 6 and 7 show block diagrams of devices that support techniques for a configuration of PSI field semantics and QoS provisioning in accordance with one or more aspects of the present disclosure.

FIG. 8 shows a block diagram of a communications manager that supports techniques for a configuration of PSI field semantics and QoS provisioning in accordance with one or more aspects of the present disclosure.

FIG. 9 shows a diagram of a system including a device that supports techniques for a configuration of PSI field semantics and QoS provisioning in accordance with one or more aspects of the present disclosure.

FIGS. 10 and 11 show block diagrams of devices that support techniques for a configuration of PSI field semantics and QoS provisioning in accordance with one or more aspects of the present disclosure.

FIG. 12 shows a block diagram of a communications manager that supports techniques for a configuration of PSI field semantics and QoS provisioning in accordance with one or more aspects of the present disclosure.

FIG. 13 shows a diagram of a system including a device that supports techniques for a configuration of PSI field semantics and QoS provisioning in accordance with one or more aspects of the present disclosure.

FIGS. 14-19 show flowcharts illustrating methods that support techniques for a configuration of PSI field semantics and QoS provisioning in accordance with one or more aspects of the present disclosure.

### DETAILED DESCRIPTION

In some wireless communication systems, one or more devices (e.g., one or more user equipment (UEs), one or more network entities, one or more nodes, or one or more of any other type of device capable of wired or wireless communication) may communicate (e.g., transmit or receive, or both) one or more protocol data units (PDUs) of one or more PDU sets. A PDU set may refer to or include one or more PDUs carrying a payload of one unit of information generated at an application level (e.g., frame(s), video slice(s), etc. for extended reality (XR) services). In some systems, a PDU may include a PDU header, which may be understood as or include a real-time transport protocol (RTP) header. Some PDU headers may include an RTP header extension. A PDU header (e.g., an RTP header extension, which may be used for PDU set marking) may include a PDU set importance (PSI) field. A PSI field may include 4 bits. A PSI field may indicate, for example, a priority of a PDU set (e.g., based on media types) or may indicate dependencies among PDU sets. A relatively lower PSI field value may indicate a relatively higher priority.

In some systems, however, various communicating devices may lack a signaling mechanism to define, configure, adjust, update, set, or otherwise synchronize on a meaning or an interpretation of PSI field values. For example, some systems may support various options on how a PSI field might be used, but such systems lack a signaling mechanism according to which multiple communicating devices can achieve synchronization regarding the use (e.g., the meaning or interpretation, such as the semantics) of a PSI field. Further, such options supported by some systems may be based on or otherwise associated with existing video codecs and applications and may lack flexibility to accommodate other video codec or application types that communicating devices may implement in the future.

In accordance with some example implementations, two or more of various (wired or wireless) devices or entities may support one or more signaling- or configuration-based mechanisms according to which such devices or entities may communicate information associated with (e.g., a configuration of) an interpretation of (e.g., a use, meaning, or semantics of) a PSI field of a PDU header. Such communication of the information associated with the interpretation of the PSI field may include a communication (e.g., a transmission or reception) of one or more messages (e.g., one or more Session Description Protocol (SDP) or Session Initiation Protocol (SIP) messages), one or more PDUs, one or more packets, one or more information elements, one or more medium access control (MAC) control elements (MAC-CEs), one or more downlink control information (DCI), uplink control information (UCI), or sidelink control information (SCI) messages, or any other wired or wireless signaling formats. In accordance with communicating the information associated with the interpretation of the PSI field, a device or entity may communicate one or more PDUs (or may otherwise perform communication associated with providing the one or more PDUs, such as communication associated with encapsulating, relaying, or configuring a resource allocation for the one or more PDUs) associated with an application in accordance with the interpretation. The indicated interpretation may define, specify, or indicate how a device or entity is to use, process, treat, parse, allocate resources for, or otherwise communicate (e.g., transmit or receive) PDU sets conveying a given PSI field value.

In accordance with communicating information associated with an interpretation of a PSI field, various devices or entities may achieve greater synchronization regarding an intended interpretation of a PSI field and may have greater flexibility or control to change the interpretation of the PSI field over time. In accordance with such greater synchronization, a device or entity may appropriately (e.g., in line with an expectation) transmit (e.g., in accordance with a selected set of communication parameters) or provide resources for one or more PDUs of one or more PDU sets, which may support more timely PDU set delivery, fewer PDU set delay budget failures, higher data rates, and greater spectral efficiency. Moreover, in accordance with such greater flexibility and control, a device or entity may dynamically, semi-persistently, or periodically update the interpretation of the PSI field such that the interpretation of the PSI field is adapted to a specific application, a specific deployment scenario, or a specific performance indicator associated with the device or entity. Thus, the device or entity may provide a greater user experience, reduced complexity, more efficient processing, and reduced power consumption related to such reduced complexity and more efficient processing.

Additionally, or alternatively, two or more of various (wired or wireless) devices or entities may support one or more signaling- or configuration-based mechanisms according to which such devices or entities may select communication parameters in accordance with a media type or a PSI field value associated with one or more PDUs (of a PDU set). In other words, a device or entity may use a media type or a PSI field value to select one or more communication parameters (e.g., one or more quality of service (QOS) parameters). In such implementations, the device or entity may transmit the one or more PDUs in accordance with the set of communication parameters. In accordance with such a selection of communication parameters for one or more PDUs in accordance with a media type or a PSI field value associated with the one or more PDUs (e.g., included or indicated via a header of the one or more PDUs), the device or entity may more dynamically select relatively more suitable communication parameters for a given set of one or more PDUs, which may provide fewer communication errors, more timely PDU set delivery, fewer PDU set delay budget failures, higher data rates, and greater spectral efficiency.

Additionally, or alternatively, two or more of various (wired or wireless) devices or entities may support one or more signaling- or configuration-based mechanisms according to which such devices or entities may communicate information associated with a mapping between PDU sets and sets of communication parameters. For example, such information may indicate a mapping between each PDU set of multiple PDU sets and a respective set of communication parameters. Such communication parameters may include QoS parameters. In other words, the mapping may correspond respective PDU sets to respective sets of communication parameters instead of, or in addition to, indicating a mapping between respective QoS flows and respective sets of communication parameters. In such implementations, a device or entity may select a set of communication parameters for a PDU set in accordance with the mapping and transmit the PDU set (e.g., the one or more PDUs of the PDU set) in accordance with the selected set of communication parameters. In accordance with such a mapping and such a selection, the device or entity may more dynamically select relatively more suitable communication parameters for a given PDU set (as different PDU sets, even those associated with a same QoS flow, may be associated with different traffic types, such as different media types), which may provide fewer communication errors, more timely PDU set delivery, fewer PDU set delay budget failures, higher data rates, and greater spectral efficiency.

As used herein, “satisfying a threshold” may, depending on the context, refer to a value being greater than the threshold, greater than or equal to the threshold, less than the threshold, less than or equal to the threshold, equal to the threshold, not equal to the threshold, or the like. Further, as used herein, a phrase referring to “at least one of” or “one or more of” a list of items refers to any combination of those items, including single members. Further, as described herein, a “network entity” may refer to any one or more network components, network devices, network nodes, network functions (or, equivalently, “functionalities”), or any combination thereof. For example, a network entity may be or refer to a gNB, a base station, an application function (AF), a policy control function (PCF), a session management function (SMF), a user plane function (UPF), a server, or any one or more devices, components, or interfaces associated with any of such entities. A network entity may support wired communication, wireless communication, or any combination thereof. Further, as described herein, a “device” may be or refer to a UE, a server, a gNB, a base station, or any other device that might serve as or be associated with an RTP endpoint. A device may support wired communication, wireless communication, or any combination thereof. Further, as described herein, “communicating” may refer to transmitting or receiving, or both.

Aspects of the disclosure are initially described in the context of wireless communications systems. Aspects of the disclosure are further illustrated by and described with reference to apparatus diagrams, system diagrams, and flowcharts that relate to techniques for a configuration of PSI field semantics and QoS provisioning. Aspects of the disclosure are further described in the context of various process flows that relate to techniques for a configuration of PSI field semantics and QoS provisioning.

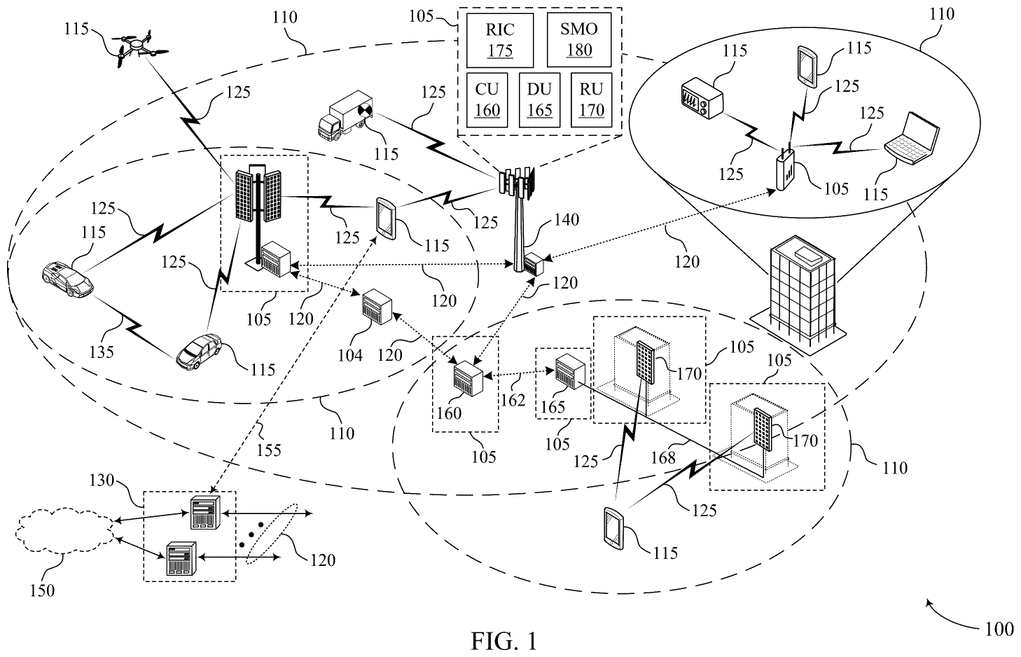

FIG. 1 shows an example of a wireless communications system 100 that supports techniques for a configuration of PSI field semantics and QoS provisioning in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, such as a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a UPF). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The UEs 115 and the network entities 105 of the wireless communications system 100 may communicate data in the form of one or more PDUs. In some scenarios, one or more of such devices may communicate one or more PDUs as part of a PDU set. A PDU set may be defined or understood as one or more PDUs carrying a payload of one unit of information generated at an application level. For example, a PDU set may include one or more PDUs that carry or are otherwise indicative of one or more frames or one or more video slices associated with an application, such as an XR application, a virtual reality (VR) application, a mixed reality (MR) application, or an augmented reality (AR) application, among other examples. A PDU set marking RTP header extension may include a PSI field and, in some systems, one or more devices may support guidelines on the use of the PSI field (e.g., based on at least one of media types or dependencies among PDU sets). In some systems, however, such guidelines may be based on existing video codecs and applications. In other words, such guidelines may lack flexibility to support future codecs and applications. By way of example, in autonomous applications, there may be 16 types of data (including text, audio, video, telemetry, etc.) and the guidelines that some systems use may be insufficient to support 16 types of data. Some systems may use other approaches to marking packets, such as differentiated services code point (DSCP) in an IP packet header. DSCP marking, however, is based on a notion of IP packets as opposed to PDU sets. Further, routers may modify a DSCP value, potentially resulting in inconsistent markings or a marking mechanism that is otherwise uncontrollable (e.g., unpredictable) in some settings.

In accordance with some example implementations, two or more of various (wired or wireless) devices or entities (e.g., one or more UEs 115 or one or more network entities 105, or any combination thereof) may support one or more signaling- or configuration-based mechanisms according to which such devices or entities may communicate information associated with (e.g., a configuration of) an interpretation of (e.g., semantics of) a PSI field of a PDU header. In accordance with communicating the information associated with the interpretation of the PSI field, a device or entity may communicate one or more PDUs (or may otherwise perform communication associated with providing the one or more PDUs, such as communication associated with encapsulating, relaying, or configuring a resource allocation for the one or more PDUs) associated with an application in accordance with the interpretation. The indicated interpretation may define, specify, or indicate how a device or entity is to treat, parse, allocate, or otherwise communicate (e.g., transmit or receive) PDU sets conveying a given PSI field value.

Additionally, or alternatively, two or more of various (wired or wireless) devices or entities may support one or more signaling- or configuration-based mechanisms according to which such devices or entities may select communication parameters in accordance with a media type or a PSI field value associated with one or more PDUs (of a PDU set). In other words, a device or entity may use a media type or a PSI field value to select one or more communication parameters (e.g., one or more QoS parameters). In such implementations, the device or entity may transmit the one or more PDUs in accordance with the set of communication parameters.

Additionally, or alternatively, two or more of various (wired or wireless) devices or entities may support one or more signaling- or configuration-based mechanisms according to which such devices or entities may communicate information associated with a mapping between PDU sets and sets of communication parameters. For example, such information may indicate a mapping between each PDU set of multiple PDU sets and a respective set of communication parameters. Such communication parameters may include QoS parameters. In other words, the mapping may correspond respective PDU sets to respective sets of communication parameters instead of, or in addition to, indicating a mapping between respective QoS flows and respective sets of communication parameters. In such implementations, a device or entity may select a set of communication parameters for a PDU set in accordance with the mapping and transmit the PDU set (e.g., the one or more PDUs of the PDU set) in accordance with the selected set of communication parameters.

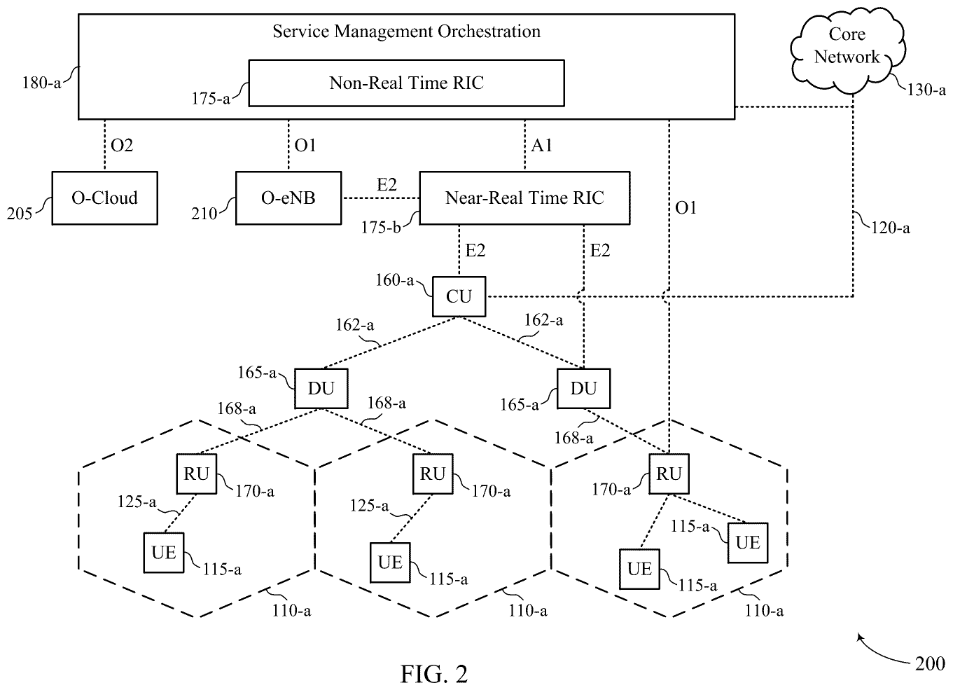

FIG. 2 shows an example of a network architecture 200 (e.g., a disaggregated base station architecture, a disaggregated RAN architecture) that supports techniques for a configuration of PSI field semantics and QoS provisioning in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled with or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

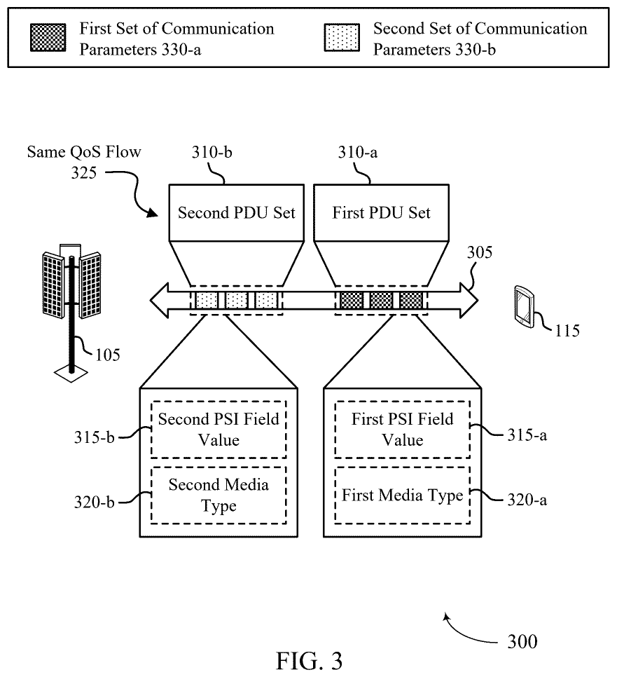

FIG. 3 shows a signaling diagram 300 that supports techniques for a configuration of PSI field semantics and QoS provisioning in accordance with one or more aspects of the present disclosure. The signaling diagram 300 illustrates communication between a UE 115 and a network entity 105, which may be examples of corresponding devices illustrated and described herein. The UE 115 and the network entity 105 may communicate via a communication link 305, which may be presentative of an uplink or a downlink, or both.

In some implementations, the UE 115, the network entity 105, or another network device, node, or functionality may support a mechanism according to which respective sets of communication parameters may be selected for communication (e.g., transmission or reception) of respective PDU sets. In other words, the UE 115 and the network entity 105 may communicate PDUs in accordance with selecting communication parameters on a PDU set level of granularity. For example, the UE 115 and the network entity 105 may communicate a first PDU set 310-a and a second PDU set 310-b. The first PDU set 310-a may be associated with a first PSI field value 315-a or a first media type 320-a, or both. The second PDU set 310-b may be associated with a second PSI field value 315-b or a second media type 320-b, or both. In some examples, the first PDU set 310-a and the second PDU set 310-b may be associated with a same QoS flow 325.

In accordance with selecting communication parameters on a PDU set level of granularity, the first PDU set 310-a may be associated with a first set of communication parameters 330-a (e.g., a first set of QoS parameters) and the second PDU set 310-b may be associated with a second set of communication parameters 330-b (e.g., a second set of QoS parameters). The UE 115, the network entity 105, or another network device, node, or functionality may select the first set of communication parameters 330-a for communication of the first PDU set 310-a in accordance with the first PSI field value 315-a or the first media type 320-a, or both, associated with the first PDU set 310-a. The UE 115, the network entity 105, or another network device, node, or functionality may select the second set of communication parameters 330-b for communication of the second PDU set 310-b in accordance with the second PSI field value 315-b or the second media type 320-b, or both, associated with the second PDU set 310-b.

The first PDU set 310-a and the second PDU set 310-b may be associated with an application. In some implementations, the application may signal (e.g., send or transmit) a semantics (e.g., an interpretation) of a PSI field. For example, an application on an RTP endpoint (e.g., the UE 115 or a server) may signal a configuration of the semantics for the PSI field. In some examples, the signaling may be sent from one endpoint to the other endpoint, such as in an SDP message, and the network (e.g., a PCF) may obtain the mapping. For example, a proxy-call session control function (P-CSCF) may intercept the mapping in case of IMS or a media session handler (MSH) on the UE 115 may extract the mapping and send an indication of the mapping to an AF in case of web real-time communication (WebRTC). Additionally, or alternatively, in some examples, the signaling may be in a form of a request to a core network, such as by extending a PDU session modification request message to include the semantics. In such examples, the request may be followed by a PDU session modification command or acknowledgment (ACK).

In some examples, a content of the signaling may include or indicate a mapping between a traffic type (e.g., a media type) of a PDU set and a PSI field value. Such a mapping may indicate that each media type of a set of media types corresponds to a respective PSI field value of a set of possible PSI field values. For example, the mapping may indicate that a media type of ‘text’ corresponds to a PSI field value equal to 15, that a media type of ‘telemetry (sensor data)’ corresponds to a PSI field value equal to 2, that a media type of ‘audio’ corresponds to a PSI field value equal to 3, that a media type of ‘video (I-frame)’ corresponds to a PSI field value equal to 5, that a media type of ‘video (P-frame)’ corresponds to a PSI field value equal to 7, or any combination thereof.

Additionally, or alternatively, a content of the signaling may include or indicate relations (e.g., a dependency) among PDU sets. There may be multiple dependency relationships between PDU sets. Such a relation or dependency may include an audio dependency relationship. For example, in audio coding (e.g., immersive voice and audio services (IVAS)), an audio encoder may generate both audio data and audio metadata (e.g., azimuth, elevation, radius, pitch, and yaw), and the audio data may depend on the audio metadata. The PDU set carrying the audio data may be marked with a PSI field value equal to 5 and the PDU set carrying the audio metadata may be marked with a PSI field value equal to 4. In such examples, the signaling may indicate that a PDU set with a PSI field value equal to 5 depends on a PDU set with a PSI field value equal to 4. By way of further example, another relation or dependency may include a video dependency relationship. For example, a P-frame may reference an I-frame, which may create a dependency relationship between a PDU set carrying one or more P-frames and a PDU set carrying one or more I-frames. The signaling may indicate that a PDU set with a PSI field value equal to 7 (e.g., which may correspond to a PDU set carrying a P-frame, such as in accordance with an indicated or default mapping) depends on a PDU set with a PSI field value equal to 6 (e.g., which may correspond to a PDU set carrying an I-frame, such as in accordance with an indicated or default mapping, as a reference of the P-frame). In this example, a PDU set marked with a PSI field value equal to 6 may not depend on a PDU set marked with a PSI field value equal to 4, although the PSI field value of the former is greater than the latter.

In some examples, a content of the signaling may include or indicate an association of (e.g., a mapping between) a set of PDU set QoS parameters and a PSI field value or a media type, or both. Such an association or mapping may be different than a QoS flow based PDU set QoS framework supported by some systems, as QoS parameters (or, more generally, communication parameters) may be selected on a PDU set level of granularity as opposed to on a QoS flow level of granularity. In such examples, the association may indicate that a (e.g., each) PSI field value or a (e.g., each) media type corresponds to a respective set of communication parameters (e.g., a respective set of QoS parameters). For example, the association may indicate that a PSI field value equal to 3 or a first media type (such as a media type that corresponds to PSI=3) corresponds to a first set of communication parameters, that a PSI field value equal to 4 or a second media type (such as a media type that corresponds to PSI=4) corresponds to a second set of communication parameters, and that a PSI field value equal to 5 or a third media type (such as a media type that corresponds to PSI=5) corresponds to a third set of communication parameters. By way of example, the first set of communication parameters may include a PDU set delay budget (PSDB) equal to 20 milliseconds and a PDU set error rate (PSER) equal to 0.01%. By way of further example, the second set of communication parameters may include a PSDB equal to 40 milliseconds and a PSER equal to 0.1%. By way of further example, the third set of communication parameters may include a PSDB equal to 50 milliseconds and a PSER equal to 1%.

The network entity 105 may adjust a resource allocation in accordance with receiving the signaling. In some examples, the network (e.g., a PCF) may re-configure the PDU set QoS parameters in accordance with the signaling. In some examples, for downlink traffic, the UPF may identify a QoS flow based on a PSI field value (and/or a media type) and one or more other attributes (e.g., an IP 5-tuple). For uplink traffic, the UE 115 may identify a QoS flow based on a PSI field value (and/or a media type) and one or more other attributes (e.g., an IP 5-tuple). Additionally, or alternatively, the network (e.g., the PCF) may map a media type (or, equivalently, a PSI field value) to a set of PDU set QoS parameters (e.g., PSDB, PSER, or PDU set integrated handling information (PSIHI), among other examples). PSIHI may indicate whether PDUs of a PDU set are to be handled as a whole, such as whether PDUs of the PDU set are expected to be delivered in their entirety or, otherwise, dropped. In other words, PSIHI may indicate that one or more PDUs of the PDU set can be delivered while one or more other PDUs of the PDU set are dropped or that either all PDUs of the PDU set are delivered or all are dropped. In such examples, the network (e.g., the PCF) may send the mapping to one or more other network entities, such as one or more of an SMF, a UPF, or a RAN node. In some examples, the network may signal the relations to the SMF, the UPF, or the RAN node as an input for resource allocation. In some examples, the network may accept or modify the request and may configure the SMF, the UPF, or the RAN node for resource allocation in accordance with the accepted or modified request.

In some implementations, the network may signal a PSI configuration. For example, the network may signal the semantics (e.g., the interpretation) of the PSI field. In some examples, the network may map or remap the PSI field values and traffic types (e.g., media types) and may signal the mapping (e.g., via an AF) to an application. In some examples, the network may signal the mapping to the application based on a request (e.g., in a PDU session modification request message), which may suggest a new mapping, from the RAN node under one or more specific conditions (e.g., congestion or a consistently high network load, such as above a threshold congestion or above a threshold network load). For example, a gNB may observe significant PSER (e.g., a PSER above a PSER threshold) and that the PSERs for I-frames and for P-frames are similar. In such examples, to improve a quality of experience (QoE), the gNB may suggest (in the request) prioritizing I-frames more and de-prioritizing P-frames further by lowering the PSI field value for PDU sets associated with I-frames and increasing the PSI field value for PDU sets associated with P-frames. In some examples, the network may signal the mapping to the application based on QoS metrics or QoE metrics reports, such as those sent from the UE 115 or a gNB to an operations, administration, and maintenance (OAM) function. In such examples, and referring to the example in which significant PSERs are present, a gNB may not observe but rather may report one or more QoS/QoE metrics to the OAM function, which may forward (in accordance with a request from the PCF) the report to the PCF, and the PCF may adjust the PSI field values for I-frame PDU sets and for P-frame PDU sets.

In some examples, the network may signal the relations (e.g., the dependency) to the application, the UPF, or a RAN node. In some examples, the network may signal an association of a set of PDU set QoS parameters (or, more generally, a set of communication parameters) and a PSI field value (and/or a media type) to the UPF and the RAN node. The application may apply the re-mapping to future traffic in accordance with receiving the signaling from the network.

In some examples, the UE 115 and the network entity 105 may support QoS flow definition considering (e.g., accounting for or otherwise factoring in) PSI. In some systems, a QoS flow may be defined by a packet filter, which includes IP 5-tuple, type of service (TOS), and source and destination MAC addresses, among other examples. An IP packet filter set may define that, for an IP PDU session type, the packet filter set may support packet filters based on at least any combination of source/destination IP address or IPv6 prefix, Source/destination port number, protocol ID of the protocol above IP/Next header type, TOS (IPv4)/traffic class (IPv6) and mask, flow label (IPv6), security parameter index, or packet filter direction. By way of example, an Ethernet packet filter set may define that, for an Ethernet PDU session type, the packet filter set may support packet filters based on at least any combination of source/destination MAC address, Ethertype as defined in IEEE 802.3, customer-VLAN tag (C-TAG) and/or service-VLAN tag (S-TAG) VID fields as defined in IEEE Std 802.IQ, customer-VLAN tag (C-TAG) and/or Service-VLAN tag (S-TAG) PCP/DEI fields as defined in IEEE Std 802.IQ, IP packet filter Set (in the case that Ethertype indicates an IPV4/IPv6 payload), or packet filter direction.

To support a QoS flow definition considering a PSI field value (and/or a media type), in some examples, a device or entity may (e.g., in accordance with a rule) add PSI to a list of attributes that may be used to define a QoS flow for an IP packet filter or an Ethernet packet filter. For example, PSI and an IP 5-tuple (e.g., source/destination IP address or IPv6 prefix, source/destination port number, protocol ID of the protocol above IP/Next header type) may together (e.g., jointly or in combination) define a QoS flow.

Further, in some systems, PDU set QoS parameters may be selected (e.g., identified, determined, or used) at the flow-level granularity, such that all the PDU sets in a same QoS flow (such as the same QoS flow 325) will have a same set of parameters (including PSI). For example, PDU set QoS parameters may be used to support PDU set based QoS handling in the NG-RAN. At least one PDU set QoS parameters may be sent to the NG-RAN to enable PDU set based QoS handling. As described herein, PDU set QoS parameters may include PSDB, PSER, and PSIHI. For a given QoS flow, the values of PSDB, PSER, and PSIHI may be different for uplink and downlink. Such a selection of PDU set QoS parameters at the flow-level granularity may result in a network being unable to differentiate a treatment of different application data units (e.g., I-frame vs. P-frame) multiplexed on the same QoS flow.

In accordance with some example implementations, the UE 115 and the network entity 105 may support PDU set QoS parameters configuration at a PDU set level granularity. In some examples, the PDU set QoS parameters (e.g., PSDB, PSER, and PSIHI) may be specified or defined for a PDU set (e.g., with PDU sets with a same PSI field value or a same media type being treated equally), rather than (or in addition to) for a QoS flow. For example, the first set of communication parameters 330-a (e.g., a first set of QoS parameters, such as “QoS parameters 1”), which may correspond to the first PSI field value 315-a or the first media type 320-a, may include or indicate a PSDB equal to 5 milliseconds, a PSER equal to 0.001%, and PSIHI equal to ‘true.’ By way of further example, the second set of communication parameters 330-b (e.g., a second set of QoS parameters, such as “QoS parameters 2”), which may correspond to the second PSI field value 315-b or the second media type 320-b, may include or indicate a PSDB equal to 10 milliseconds, a PSER equal to 0.01%, and PSIHI equal to ‘false.’ In accordance with defining or specifying communication parameters for PDU sets, the UE 115 and the network entity 105 may support communication of [flow 1, PDU set 1, QoS parameters 1], [flow 1, PDU set 2, QoS parameters 2], and [flow 1, PDU set 3, QoS parameters 1]. By way of example, the PDU sets 1 and 3 may represent an I-frame and the PDU set 2 may represent a P-frame on a same QoS flow (e.g., flow 1).

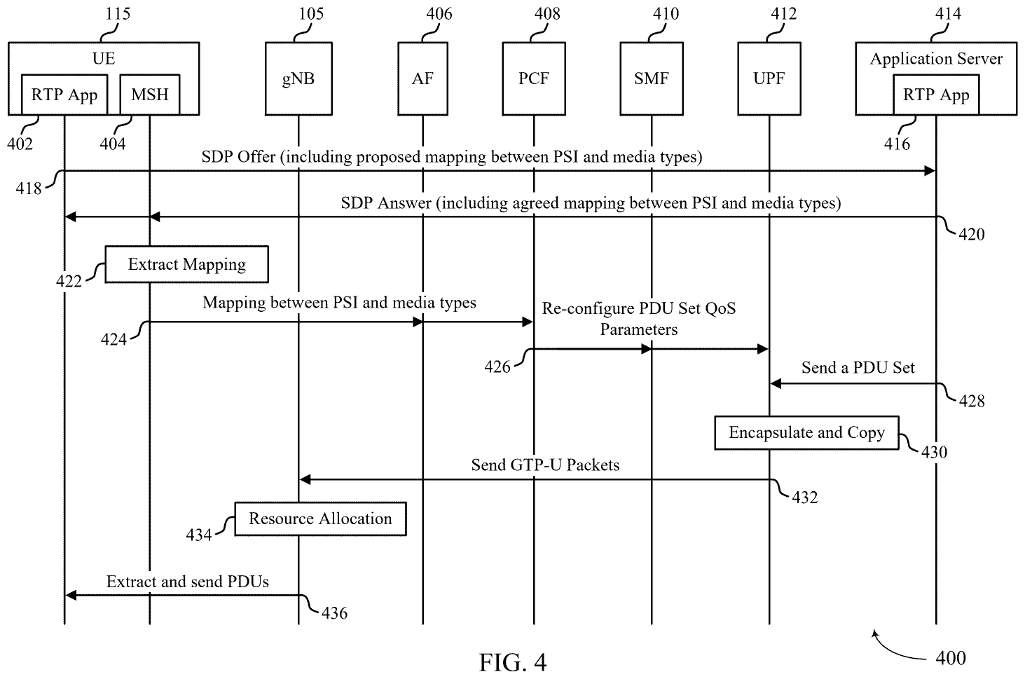

FIG. 4 shows a process flow 400 that supports techniques for a configuration of PSI field semantics and QoS provisioning in accordance with one or more aspects of the present disclosure. The process flow 400 illustrates communication between a UE 115 (which may include an RTP application 402 and an MSH 404), a network entity 105 (shown as a gNB in the example of FIG. 4), an AF 406, a PCF 408, an SMF 410, a UPF 412, and an application server 414 (which may include an RTP application 416, which may be the same as or another version of the RTP application 402). Any one or more of the devices, nodes, entities, or functions of the process flow 400 may implement one or more aspects of the present disclosure.

In accordance with the process flow 400, two or more of various (wired or wireless) devices or entities may support one or more signaling- or configuration-based mechanisms according to which such devices or entities may communicate information associated with (e.g., a configuration of) an interpretation of (e.g., use, meaning, or semantics of) a PSI field of a PDU header. Such communication of the information associated with the interpretation of the PSI field may include a communication (e.g., a transmission or reception) of one or more messages, one or more PDUs, one or more packets, one or more information elements, one or more MAC-CEs, one or more DCI, UCI, or SCI messages, or any other wired or wireless signaling formats.

In accordance with communicating the information associated with the interpretation of the PSI field, a device or entity may communicate one or more PDUs (or may otherwise perform communication associated with providing the one or more PDUs, such as communication associated with encapsulating, relaying, or configuring a resource allocation for the one or more PDUs) associated with an application in accordance with the interpretation. The indicated interpretation may define, specify, or indicate how a device or entity is to use, process, treat, parse, allocate resources for, or otherwise communicate (e.g., transmit or receive) PDU sets conveying a given PSI field value.

In the following description of the process flow 400, the operations between the various devices, nodes, entities, or functions may be performed in a different order than the example order shown. Some operations may also be omitted from the process flow 400, and other operations may be added to the process flow 400. Further, although some operations or signaling may be shown to occur at different times for discussion purposes, these operations may occur at the same time.

At 418, the UE 115 may transmit, to the RTP application 416 of the application server 414, an SDP offer. The SDP offer may include or indicate a proposed or requested mapping between PSI field values and media types.

At 420, the RTP application 416 of the application server 414 may transmit, to at least one of the RTP application 402 or the MSH 404 of the UE 115, an SDP answer. The SDP answer may include or indicate an agreed mapping between the PSI field values and the media types.

At 422, the MSH 404 of the UE 115 may extract the mapping between the PSI field values and the media types. At 424, the MSH 404 of the UE 115 may transmit, to at least one of the AF 406 or the PCF 408, an indication of the mapping between the PSI field values and the media types. At 426, the PCF 408 may transmit, to at least one of the SMF 410 or the UPF 412, an indication of a re-configuration of PDU set QoS parameters (e.g., in accordance with the mapping).

At 428, the RTP application 416 of the application server 414 may send a PDU set to the UPF 412. At 430, the UPF 412 may encapsulate PDUs of the PDU set into general packet radio service (GPRS) tunnelling protocol user plane (GTP-U) packets and copy an RTP header extension in the PDUs to respective GTP-U packet headers. At 432, the UPF 412 may send the GTP-U packets to the network entity 105 (e.g., a gNB or another RAN node). At 434, the network entity 105 may provide a resource allocation (e.g., time and frequency resources) for communication of PDUs of the PDU set from the network entity 105 to the UE 115. At 436, the network entity 105 may extract and send the PDUs of the PDU set to the UE 115, which the UE 115 may provide to the RTP application 402 of the UE 115.

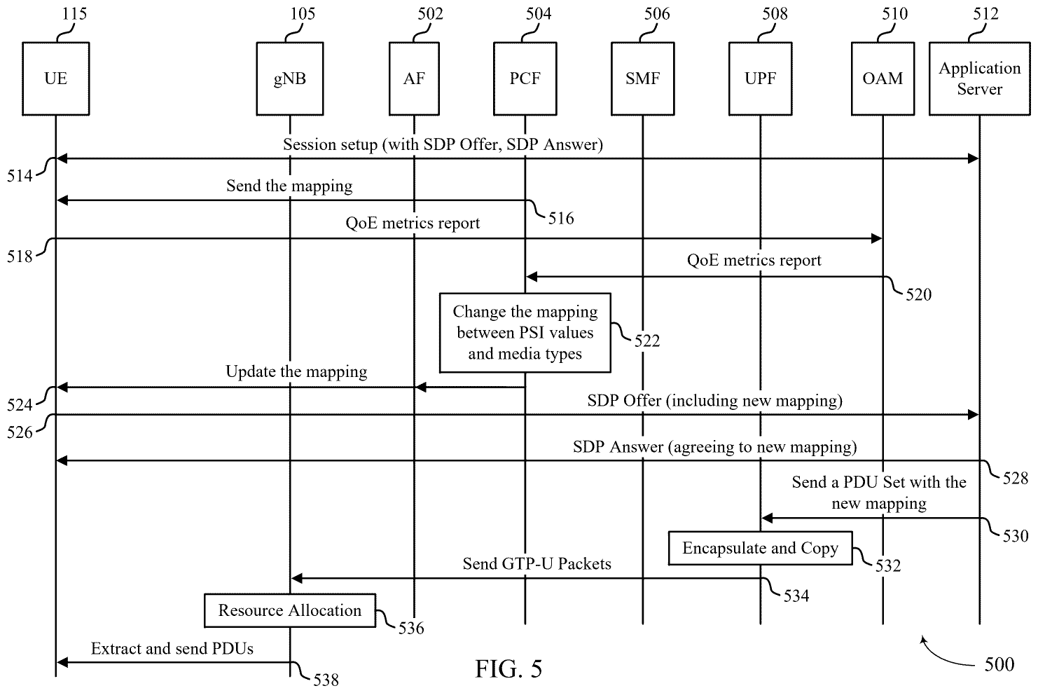

FIG. 5 shows a process flow 500 that supports techniques for a configuration of PSI field semantics and QoS provisioning in accordance with one or more aspects of the present disclosure. The process flow 500 illustrates communication between a UE 115, a network entity 105 (shown as a gNB in the example of FIG. 5), an AF 502, a PCF 504, an SMF 506, a UPF 508, an OAM function 510, and an application server 512. Any one or more of the devices, nodes, entities, or functions of the process flow 500 may implement one or more aspects of the present disclosure.

In accordance with the process flow 500, two or more of various (wired or wireless) devices or entities may support one or more signaling- or configuration-based mechanisms according to which such devices or entities may communicate information associated with (e.g., a configuration of) an interpretation of (e.g., use, meaning, or semantics of) a PSI field of a PDU header. Such communication of the information associated with the interpretation of the PSI field may include a communication (e.g., a transmission or reception) of one or more messages, one or more PDUs, one or more packets, one or more information elements, one or more MAC-CEs, one or more DCI, UCI, or SCI messages, or any other wired or wireless signaling formats.

In accordance with communicating the information associated with the interpretation of the PSI field, a device or entity may communicate one or more PDUs (or may otherwise perform communication associated with providing the one or more PDUs, such as communication associated with encapsulating, relaying, or configuring a resource allocation for the one or more PDUs) associated with an application in accordance with the interpretation. The indicated interpretation may define, specify, or indicate how a device or entity is to use, process, treat, parse, allocate resources for, or otherwise communicate (e.g., transmit or receive) PDU sets conveying a given PSI field value.

In the following description of the process flow 500, the operations between the various devices, nodes, entities, or functions may be performed in a different order than the example order shown. Some operations may also be omitted from the process flow 500, and other operations may be added to the process flow 500. Further, although some operations or signaling may be shown to occur at different times for discussion purposes, these operations may occur at the same time.

At 514, the UE 115 and the application server 512 may participate in or otherwise perform a session setup. Such a session setup may include a transmission of an SDP offer from the UE 115 to the application server 512 and a transmission of an SDP answer from the application server 512 to the UE 115. The session setup may negotiate, coordinate, or indicate a mapping between PSI field values and media types.

At 516, the PCF 504 may transmit, to the UE 115, an indication of the mapping between the PSI field values and the media types. At 518, the UE 115 may transmit a QoE metrics report to the OAM function 510. At 520, the OAM function 510 may transmit (e.g., forward or relay) the QoE metrics report to the PCF 504. At 522, the PCF 504 may change the mapping between the PSI field values and the media types (e.g., in accordance with the QoE metrics report). At 524, the PCF 504 may update the mapping to at least one of the AF 502 or the UE 115. For example, the PCF 504 may transmit an indication of the updated mapping to at least one of the AF 502 or the UE 115.

At 526, the UE 115 may transmit an SDP offer to the application server 512. The SDP offer may include or indicate the new (e.g., updated) mapping (e.g., as indicated to the UE 115 from the PCF 504). At 528, the application server 512 may transmit an SDP answer to the UE 115. The SDP answer may include or indicate an agreement to the new (e.g., updated) mapping.

At 530, the application server 512 may send, to the UPF 508, a PDU set in accordance with the new mapping. At 532, the UPF 508 may encapsulate PDUs of the PDU set into GTP-U packets and copy an RTP header extension in the PDUs to respective GTP-U packet headers. At 534, the UPF 508 may send the GTP-U packets to the network entity 105 (e.g., a gNB or another RAN node). At 536, the network entity 105 may provide a resource allocation (e.g., time and frequency resources) for communication of PDUs of the PDU set from the network entity 105 to the UE 115. At 538, the network entity 105 may extract and send the PDUs of the PDU set to the UE 115.

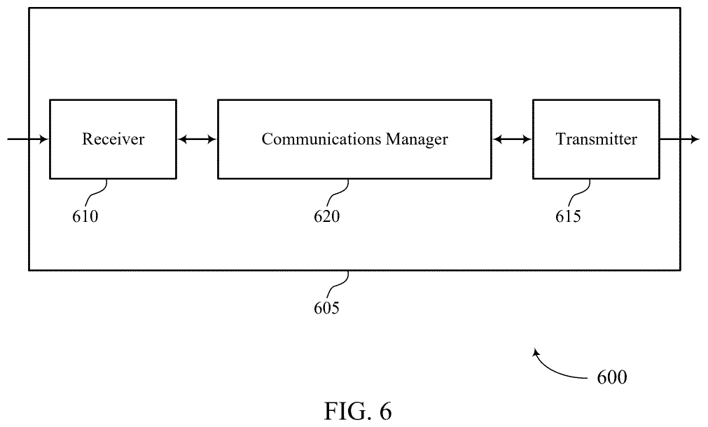

FIG. 6 shows a block diagram 600 of a device 605 that supports techniques for a configuration of PSI field semantics and QoS provisioning in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for a configuration of PSI field semantics and QoS provisioning). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for a configuration of PSI field semantics and QoS provisioning). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of techniques for a configuration of PSI field semantics and QoS provisioning as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support media session management in accordance with examples as disclosed herein. For example, the communications manager 620 is capable of, configured to, or operable to support a means for establishing a PDU session between the first device and a second device in accordance with an application at the first device. The communications manager 620 is capable of, configured to, or operable to support a means for communicating, in association with establishing the PDU session, a first communication of information associated with an interpretation of a PSI field of a PDU header. The communications manager 620 is capable of, configured to, or operable to support a means for communicating a second communication of one or more PDUs of one or more PDU sets associated with the application in accordance with the interpretation of the PSI field.

Additionally, or alternatively, the communications manager 620 may support media session management in accordance with examples as disclosed herein. For example, the communications manager 620 is capable of, configured to, or operable to support a means for establishing a session between the first device and a second device in accordance with an application at the first device. The communications manager 620 is capable of, configured to, or operable to support a means for selecting a set of communication parameters for one or more PDUs associated with the application in accordance with a media type (as indicated by a field value, such as a PSI field value) associated with the one or more PDUs. The communications manager 620 is capable of, configured to, or operable to support a means for transmitting the one or more PDUs in accordance with the set of communication parameters.

Additionally, or alternatively, the communications manager 620 may support media session management in accordance with examples as disclosed herein. For example, the communications manager 620 is capable of, configured to, or operable to support a means for establishing a PDU session between the first device and a second device in accordance with an application at the first device. The communications manager 620 is capable of, configured to, or operable to support a means for receiving, in association with establishing the PDU session, information associated with a mapping between each PDU set of a set of multiple PDU sets and a respective set of communication parameters. The communications manager 620 is capable of, configured to, or operable to support a means for selecting a first set of communication parameters for a first PDU set associated with the application in accordance with the mapping. The communications manager 620 is capable of, configured to, or operable to support a means for transmitting the first PDU set in accordance with the first set of communication parameters.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

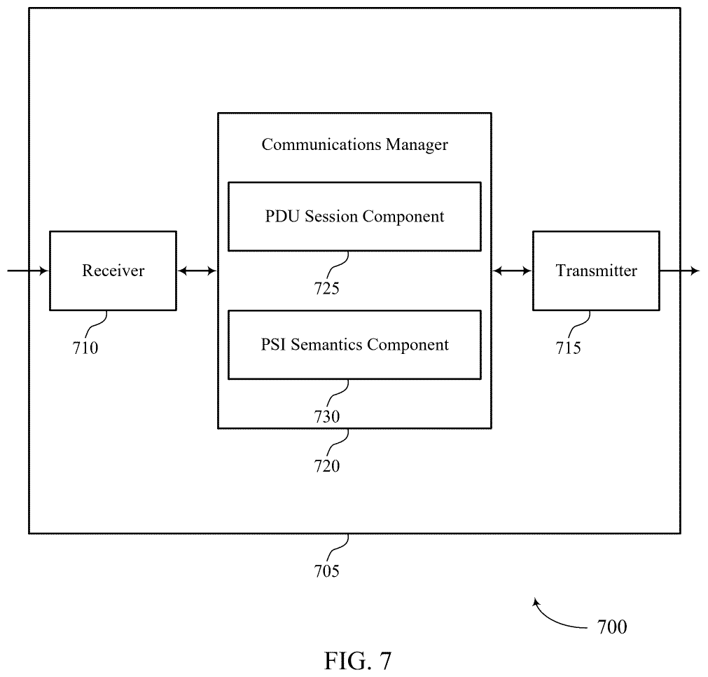

FIG. 7 shows a block diagram 700 of a device 705 that supports techniques for a configuration of PSI field semantics and QoS provisioning in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for a configuration of PSI field semantics and QoS provisioning). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for a configuration of PSI field semantics and QoS provisioning). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for a configuration of PSI field semantics and QoS provisioning as described herein. For example, the communications manager 720 may include a PDU session component 725 a PSI semantics component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support media session management in accordance with examples as disclosed herein. The PDU session component 725 is capable of, configured to, or operable to support a means for establishing a PDU session between the first device and a second device in accordance with an application at the first device. The PSI semantics component 730 is capable of, configured to, or operable to support a means for communicating, in association with establishing the PDU session, a first communication of information associated with an interpretation of a PSI field of a PDU header. The PSI semantics component 730 is capable of, configured to, or operable to support a means for communicating a second communication of one or more PDUs of one or more PDU sets associated with the application in accordance with the interpretation of the PSI field.

Additionally, or alternatively, the communications manager 720 may support media session management in accordance with examples as disclosed herein. The PDU session component 725 is capable of, configured to, or operable to support a means for establishing a PDU session between the first device and a second device in accordance with an application at the first device. The PDU session component 725 is capable of, configured to, or operable to support a means for selecting a set of communication parameters for one or more PDUs associated with the application in accordance with a media type (as indicated by a field value, such as a PSI field value) associated with the one or more PDUs. The PDU session component 725 is capable of, configured to, or operable to support a means for transmitting the one or more PDUs in accordance with the set of communication parameters.

Additionally, or alternatively, the communications manager 720 may support media session management in accordance with examples as disclosed herein. The PDU session component 725 is capable of, configured to, or operable to support a means for establishing a PDU session between the first device and a second device in accordance with an application at the first device. The PDU session component 725 is capable of, configured to, or operable to support a means for receiving, in association with establishing the PDU session, information associated with a mapping between each PDU set of a set of multiple PDU sets and a respective set of communication parameters. The PDU session component 725 is capable of, configured to, or operable to support a means for selecting a first set of communication parameters for a first PDU set associated with the application in accordance with the mapping. The PDU session component 725 is capable of, configured to, or operable to support a means for transmitting the first PDU set in accordance with the first set of communication parameters.

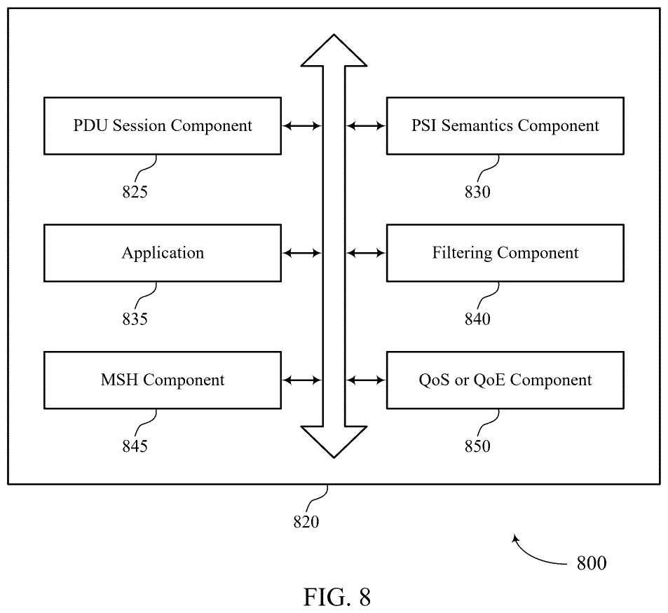

FIG. 8 shows a block diagram 800 of a communications manager 820 that supports techniques for a configuration of PSI field semantics and QoS provisioning in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for a configuration of PSI field semantics and QoS provisioning as described herein. For example, the communications manager 820 may include a PDU session component 825, a PSI semantics component 830, an application 835, a filtering component 840, an MSH component 845, a QoS or QoE component 850, or any combination thereof. Each of these components, or components or subcomponents thereof (e.g., one or more processors, one or more memories), may communicate, directly or indirectly, with one another (e.g., via one or more buses).

The communications manager 820 may support media session management in accordance with examples as disclosed herein. The PDU session component 825 is capable of, configured to, or operable to support a means for establishing a PDU session between the first device and a second device in accordance with an application at the first device. The PSI semantics component 830 is capable of, configured to, or operable to support a means for communicating, in association with establishing the PDU session, a first communication of information associated with an interpretation of a PSI field of a PDU header. In some examples, the PSI semantics component 830 is capable of, configured to, or operable to support a means for communicating a second communication of one or more PDUs of one or more PDU sets associated with the application in accordance with the interpretation of the PSI field.

In some examples, to support communicating the first communication of the information associated with the interpretation of the PSI field, the PSI semantics component 830 is capable of, configured to, or operable to support a means for transmitting or receiving, to or from the second device, a message including the information associated with the interpretation of the PSI field.

In some examples, the MSH component 845 is capable of, configured to, or operable to support a means for extracting, via a media session handler associated with the first device, the interpretation of the PSI field. In some examples, the MSH component 845 is capable of, configured to, or operable to support a means for transmitting the information associated with the interpretation of the PSI field to a network entity, where communicating the second communication of the one or more PDUs is in association with transmitting the information associated with the interpretation of the PSI field to the network entity.

In some examples, the network entity is an AF. In some examples, the first device extracts the interpretation of the PSI field via the media session handler in accordance with the PDU session being associated with WebRTC.

In some examples, to support communicating the first communication of the information associated with the interpretation of the PSI field, the PSI semantics component 830 is capable of, configured to, or operable to support a means for transmitting, to a network entity, a first message including a request for the interpretation of the PSI field. In some examples, to support communicating the first communication of the information associated with the interpretation of the PSI field, the PSI semantics component 830 is capable of, configured to, or operable to support a means for receiving, from the network entity, a second message including an acceptance or a modification of the interpretation of the PSI field requested by the first device, where communicating the second communication of the one or more PDUs is in accordance with the acceptance or the modification of the interpretation of the PSI field by the network entity.

In some examples, the first message is a PDU session modification request message. In some examples, the PDU session modification request message includes a field or a set of one or more bits indicative of the interpretation of the PSI field requested by the first device.

In some examples, the network entity is a core network entity.

In some examples, the PDU session component 825 is capable of, configured to, or operable to support a means for receiving second information associated with a resource allocation for the PDU session between the first device and the second device, where communicating the second communication of the one or more PDUs is in accordance with the resource allocation.

In some examples, the resource allocation indicates one or more physical resources associated with the PDU session, a first mapping between each PSI field value of a set of multiple PSI field values and a respective QoS flow, a second mapping between each PSI field value of the set of multiple PSI field values and a respective set of QoS parameters, a third mapping that associates two or more PSI field values of the set of multiple PSI field values as corresponding to PDU sets having a dependency relationship, or any combination thereof.

In some examples, the resource allocation is received from a network entity.

In some examples, to support communicating the first communication of the information associated with the interpretation of the PSI field, the PSI semantics component 830 is capable of, configured to, or operable to support a means for receiving a message including the information associated with the interpretation of the PSI field from a network entity.

In some examples, the message is received from the network entity in accordance with a satisfaction of one or more conditions. In some examples, the one or more conditions include one or both of a network congestion level satisfying a threshold network congestion level or a network load level satisfying a threshold network load level. In some examples, the one or more conditions include a PDU set error rate satisfying a threshold PDU set error rate or PDU set error rates for multiple traffic types being within a threshold proximity of each other.

In some examples, the multiple traffic types include a first traffic type associated with an I-frame of video data and a second traffic type associated with a P-frame of video data. In some examples, the interpretation of the PSI field indicates a prioritization of the I-frame of video data and a de-prioritization of the P-frame of video data by decreasing a first PSI field value that corresponds first PDU sets carrying the I-frame of video data and increasing a second PSI field value that corresponds to second PDU sets carrying the P-frame of video data.

In some examples, the QoS or QoE component 850 is capable of, configured to, or operable to support a means for transmitting second information associated with a QoS metric or a QoE (QoE) metric to the network entity, where the interpretation of the PSI field is received from the network entity in association with transmitting one or both of the QoS metric or the QoE metric to the network entity.

In some examples, the network entity forwards one or both of the QoS metric or the QoE metric to a policy control function associated with the network entity. In some examples, the policy control function generates the interpretation of the PSI

### FIELD

In some examples, the interpretation of the PSI field indicates a mapping that associates each PSI field value of a set of multiple PSI field values to a respective traffic type. In some examples, in accordance with the mapping, a first PSI field value corresponds to a first traffic type and a second PSI field value corresponds to a second traffic type. In some examples, in accordance with the mapping, a first PSI field value corresponds to telemetry data, a second PSI field value corresponds to audio data, a third PSI field value corresponds to an I-frame of video data, and a fourth PSI field value corresponds to a P-frame of video data.

In some examples, the interpretation of the PSI field indicates a mapping that associates two or more PSI field values of a set of multiple PSI field values as corresponding to PDU sets having a dependency relationship. In some examples, in accordance with the mapping, a first PDU set associated with a first PSI field value and a second PDU set associated with a second PSI field value have a first dependency relationship. In some examples, the first dependency relationship indicates that the first PDU set depends on the second PDU set. In some examples, the first PDU set is associated with audio data and the second PDU set is associated with audio metadata data. In some examples, the first PDU set is associated with a P-frame of video data and the second PDU set is associated with an I-frame of video data. In some examples, in accordance with the mapping, a third PDU set associated with a third PSI field value and a fourth PDU set associated with a fourth PSI field value have a second dependency relationship. In some examples, the second dependency relationship indicates that the third PDU set depends on the fourth PDU set.

In some examples, the interpretation of the PSI field indicates a mapping that associates each PSI field value of a set of multiple PSI field values to a respective set of communication parameters. In some examples, in accordance with the mapping, a first PSI field value corresponds to a first set of communication parameters and a second PSI field corresponds to a second set of communication parameters. In some examples, the respective set of communication parameters includes a respective set of QoS parameters. In some examples, in accordance with the mapping, a first PSI field value corresponds to a first set of QoS parameters and a second PSI field value corresponds to a second set of QoS parameters. In some examples, the first set of QoS parameters includes a first PDU set delay budget and a first PDU set error rate and the second set of QoS parameters includes a second PDU set delay budget and a second PDU set error rate.

In some examples, to support communicating the second communication of the one or more PDUs, the application 835 is capable of, configured to, or operable to support a means for obtaining a first PDU from the application. In some examples, to support communicating the second communication of the one or more PDUs, the filtering component 840 is capable of, configured to, or operable to support a means for filtering the first PDU in accordance with a packet filter that is based on a first PSI field value associated with the first PDU. In some examples, to support communicating the second communication of the one or more PDUs, the filtering component 840 is capable of, configured to, or operable to support a means for determining a first QoS flow associated with the first PDU based on the packet filter. In some examples, to support communicating the second communication of the one or more PDUs, the PDU session component 825 is capable of, configured to, or operable to support a means for transmitting the first PDU in accordance with a set of QoS parameters associated with the first QoS flow.

In some examples, the PDU session component 825 is capable of, configured to, or operable to support a means for receiving, in association with establishing the PDU session, second information associated with a mapping between each PDU set of a set of multiple PDU sets and a respective set of QoS parameters, where, in accordance with the mapping, a first PDU set of a first QoS flow is associated with a first set of QoS parameters and a second PDU set of the first QoS flow is associated with a second set of QoS parameters.

Additionally, or alternatively, the communications manager 820 may support media session management in accordance with examples as disclosed herein. In some examples, the PDU session component 825 is capable of, configured to, or operable to support a means for establishing a PDU session between the first device and a second device in accordance with an application at the first device. In some examples, the PDU session component 825 is capable of, configured to, or operable to support a means for selecting a set of communication parameters for one or more PDUs associated with the application in accordance with a media type (as indicated by a field value, such as a PSI field value) associated with the one or more PDUs. In some examples, the PDU session component 825 is capable of, configured to, or operable to support a means for transmitting the one or more PDUs in accordance with the set of communication parameters.

In some examples, the application 835 is capable of, configured to, or operable to support a means for obtaining the one or more PDUs from the application. In some examples, the filtering component 840 is capable of, configured to, or operable to support a means for filtering (e.g., grouping) the one or more PDUs to a QoS flow in accordance with a packet filter that is based on the PSI field value, where the set of communication parameters is selected in association with filtering (e.g., grouping) the one or more PDUs to the QoS flow in accordance with the packet filter that is based on the PSI field value.

In some examples, the filtering component 840 is capable of, configured to, or operable to support a means for determining a QoS flow associated with the one or more PDUs based on the packet filter, where the set of communication parameters is selected in association with determining the QoS flow associated with the one or more PDUs.

In some examples, the PSI field value and a set of Internet Protocol parameters jointly define the QoS flow in accordance with the packet filter. In some examples, a respective PSI field value and a respective set of Internet Protocol parameters jointly define a respective QoS flow in accordance with the packet filter. In some examples, the packet filter is an Internet Protocol packet filter or an Ethernet packet filter. In some examples, the set of communication parameters include a set of QoS parameters.

Additionally, or alternatively, the communications manager 820 may support media session management in accordance with examples as disclosed herein. In some examples, the PDU session component 825 is capable of, configured to, or operable to support a means for establishing a PDU session between the first device and a second device in accordance with an application at the first device. In some examples, the PDU session component 825 is capable of, configured to, or operable to support a means for receiving, in association with establishing the PDU session, information associated with a mapping between each PDU set of a set of multiple PDU sets and a respective set of communication parameters. In some examples, the PDU session component 825 is capable of, configured to, or operable to support a means for selecting a first set of communication parameters for a first PDU set associated with the application in accordance with the mapping. In some examples, the PDU session component 825 is capable of, configured to, or operable to support a means for transmitting the first PDU set in accordance with the first set of communication parameters.

In some examples, the PDU session component 825 is capable of, configured to, or operable to support a means for selecting a second set of communication parameters for a second PDU set associated with the application in accordance with the mapping. In some examples, the PDU session component 825 is capable of, configured to, or operable to support a means for transmitting the second PDU set in accordance with the second set of communication parameters.

In some examples, the first PDU set and the second PDU set are associated with a same QoS flow. In some examples, the first PDU set is associated with a first traffic type and the second PDU set is associated with a second traffic type. In some examples, the first traffic type is associated with an I-frame of video data and the second traffic type is associated with a P-frame of video data. In some examples, the first traffic type is associated with telemetry data and the second traffic type is associated with audio data. In some examples, the first traffic type is associated with audio data and the second traffic type is associated with audio metadata data.

In some examples, the first set of communication parameters include a first set of QoS parameters, and the second set of communication parameters include a second set of QoS parameters. In some examples, the first set of QoS parameters are associated with a first PDU set delay budget, a first PDU set error rate, and first PDU set integrated handling information and the second set of QoS parameters are associated with a second PDU set delay budget, a second PDU set error rate, and second PDU set integrated handling information.

In some examples, the first PDU set delay budget, the first PDU set error rate, and the first PDU set integrated handling information are different than the second PDU set delay budget, the second PDU set error rate, and the second PDU set integrated handling information, respectively, in association with the first PDU set being associated with a first PSI field value that is different than a second PSI field value associated with the second PDU set.

In some examples, the first PDU set delay budget, the first PDU set error rate, and the first PDU set integrated handling information are equal to the second PDU set delay budget, the second PDU set error rate, and the second PDU set integrated handling information, respectively, in association with the first PDU set being associated with a first PSI field value that is equal to a second PSI field value associated with the second PDU set.

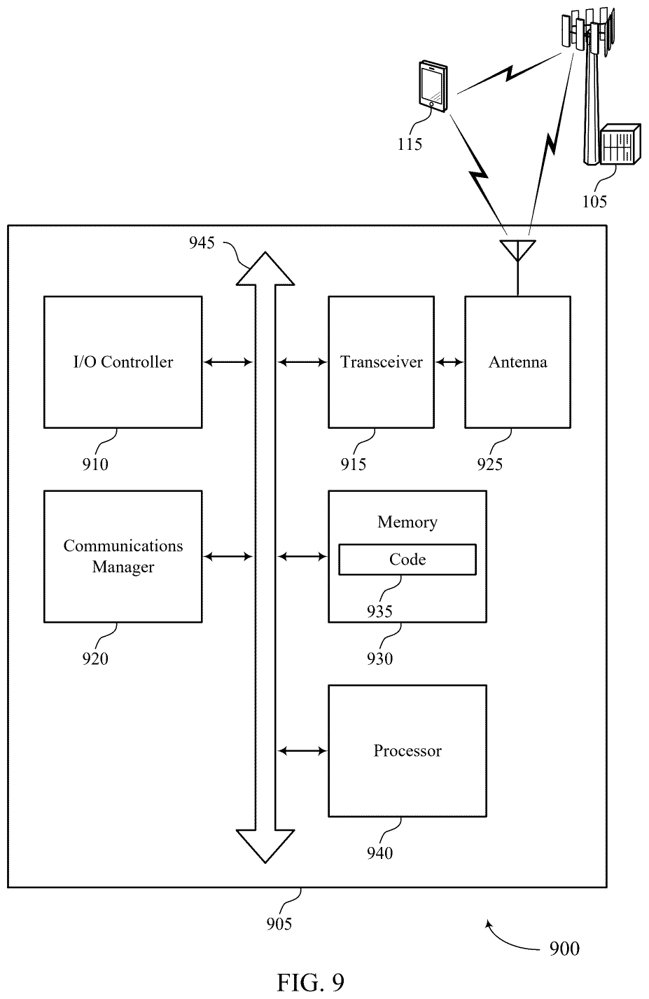

FIG. 9 shows a diagram of a system 900 including a device 905 that supports techniques for a configuration of PSI field semantics and QoS provisioning in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM), read-only memory (ROM), or any combination thereof. The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for a configuration of PSI field semantics and QoS provisioning). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support media session management in accordance with examples as disclosed herein. For example, the communications manager 920 is capable of, configured to, or operable to support a means for establishing a PDU session between the first device and a second device in accordance with an application at the first device. The communications manager 920 is capable of, configured to, or operable to support a means for communicating, in association with establishing the PDU session, a first communication of information associated with an interpretation of a PSI field of a PDU header. The communications manager 920 is capable of, configured to, or operable to support a means for communicating a second communication of one or more PDUs of one or more PDU sets associated with the application in accordance with the interpretation of the PSI field.

Additionally, or alternatively, the communications manager 920 may support media session management in accordance with examples as disclosed herein. For example, the communications manager 920 is capable of, configured to, or operable to support a means for establishing a PDU session between the first device and a second device in accordance with an application at the first device. The communications manager 920 is capable of, configured to, or operable to support a means for selecting a set of communication parameters for one or more PDUs associated with the application in accordance with a media type (as indicated by a field value, such as a PSI field value) associated with the one or more PDUs. The communications manager 920 is capable of, configured to, or operable to support a means for transmitting the one or more PDUs in accordance with the set of communication parameters.

Additionally, or alternatively, the communications manager 920 may support media session management in accordance with examples as disclosed herein. For example, the communications manager 920 is capable of, configured to, or operable to support a means for establishing a PDU session between the first device and a second device in accordance with an application at the first device. The communications manager 920 is capable of, configured to, or operable to support a means for receiving, in association with establishing the PDU session, information associated with a mapping between each PDU set of a set of multiple PDU sets and a respective set of communication parameters. The communications manager 920 is capable of, configured to, or operable to support a means for selecting a first set of communication parameters for a first PDU set associated with the application in accordance with the mapping. The communications manager 920 is capable of, configured to, or operable to support a means for transmitting the first PDU set in accordance with the first set of communication parameters.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of techniques for a configuration of PSI field semantics and QoS provisioning as described herein, or the at least one processor 940 and the at least one memory 930 may be otherwise configured to, individually or collectively, perform or support such operations.

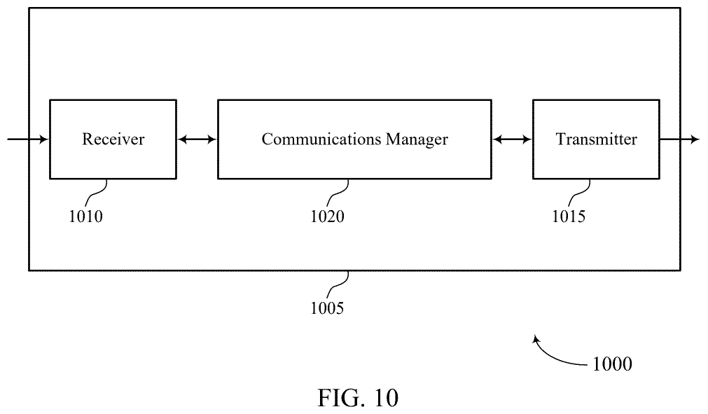

FIG. 10 shows a block diagram 1000 of a device 1005 that supports techniques for a configuration of PSI field semantics and QoS provisioning in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of techniques for a configuration of PSI field semantics and QoS provisioning as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support media session management in accordance with examples as disclosed herein. For example, the communications manager 1020 is capable of, configured to, or operable to support a means for communicating, in association with an establishment of a PDU session between a first device and a second device, a first communication of information associated with an interpretation of a PSI field of a PDU header of PDUs communicated between the first device and the second device. The communications manager 1020 is capable of, configured to, or operable to support a means for communicating a second communication associated with providing one or more PDUs of one or more PDU sets from the first device to the second device in accordance with the interpretation of the PSI field.

Additionally, or alternatively, the communications manager 1020 may support media session management in accordance with examples as disclosed herein. For example, the communications manager 1020 is capable of, configured to, or operable to support a means for obtaining one or more PDUs in association with a PDU session between a first device and a second device. The communications manager 1020 is capable of, configured to, or operable to support a means for selecting a set of communication parameters for one or more PDUs associated in accordance with a media type (as indicated by a field value, such as a PSI field value) associated with the one or more PDUs. The communications manager 1020 is capable of, configured to, or operable to support a means for transmitting the one or more PDUs in accordance with the set of communication parameters.

Additionally, or alternatively, the communications manager 1020 may support media session management in accordance with examples as disclosed herein. For example, the communications manager 1020 is capable of, configured to, or operable to support a means for transmitting, in association with an establishment of a PDU session between a first device and a second device, information associated with a mapping between each protocol PDU set of a set of multiple PDU sets and a respective set of communication parameters. The communications manager 1020 is capable of, configured to, or operable to support a means for obtaining a first PDU set in accordance with the PDU session between the first device and the second device. The communications manager 1020 is capable of, configured to, or operable to support a means for selecting a first set of communication parameters for the first PDU set associated in accordance with the mapping. The communications manager 1020 is capable of, configured to, or operable to support a means for transmitting the first PDU set in accordance with the first set of communication parameters.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources.

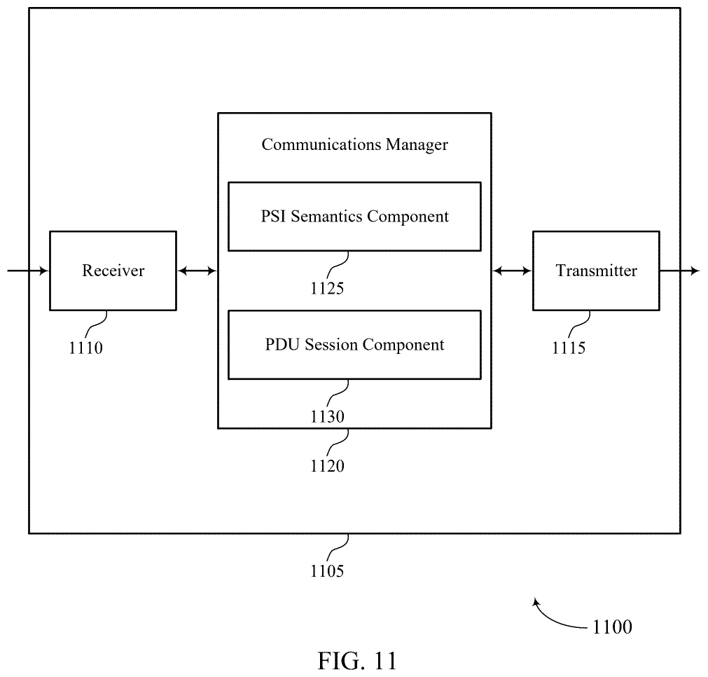

FIG. 11 shows a block diagram 1100 of a device 1105 that supports techniques for a configuration of PSI field semantics and QoS provisioning in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for a configuration of PSI field semantics and QoS provisioning as described herein. For example, the communications manager 1120 may include a PSI semantics component 1125 a PDU session component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support media session management in accordance with examples as disclosed herein. The PSI semantics component 1125 is capable of, configured to, or operable to support a means for communicating, in association with an establishment of a PDU session between a first device and a second device, a first communication of information associated with an interpretation of a PSI field of a PDU header of PDUs communicated between the first device and the second device. The PDU session component 1130 is capable of, configured to, or operable to support a means for communicating a second communication associated with providing one or more PDUs of one or more PDU sets from the first device to the second device in accordance with the interpretation of the PSI field.

Additionally, or alternatively, the communications manager 1120 may support media session management in accordance with examples as disclosed herein. The PDU session component 1130 is capable of, configured to, or operable to support a means for obtaining one or more PDUs in association with a PDU session between a first device and a second device. The PDU session component 1130 is capable of, configured to, or operable to support a means for selecting a set of communication parameters for one or more PDUs associated in accordance with a media type (as indicated by a field value, such as a PSI field value) associated with the one or more PDUs. The PDU session component 1130 is capable of, configured to, or operable to support a means for transmitting the one or more PDUs in accordance with the set of communication parameters.

Additionally, or alternatively, the communications manager 1120 may support media session management in accordance with examples as disclosed herein. The PDU session component 1130 is capable of, configured to, or operable to support a means for transmitting, in association with an establishment of a PDU session between a first device and a second device, information associated with a mapping between each protocol PDU set of a set of multiple PDU sets and a respective set of communication parameters. The PDU session component 1130 is capable of, configured to, or operable to support a means for obtaining a first PDU set in accordance with the PDU session between the first device and the second device. The PDU session component 1130 is capable of, configured to, or operable to support a means for selecting a first set of communication parameters for the first PDU set associated in accordance with the mapping. The PDU session component 1130 is capable of, configured to, or operable to support a means for transmitting the first PDU set in accordance with the first set of communication parameters.

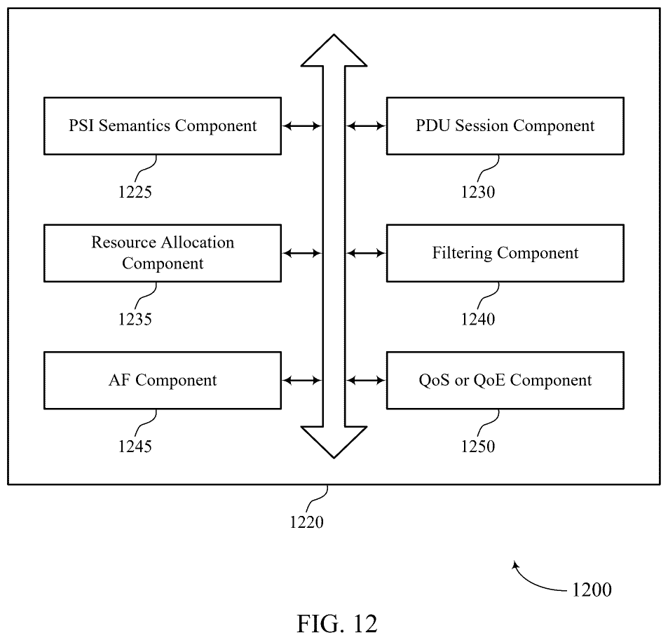

FIG. 12 shows a block diagram 1200 of a communications manager 1220 that supports techniques for a configuration of PSI field semantics and QoS provisioning in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for a configuration of PSI field semantics and QoS provisioning as described herein. For example, the communications manager 1220 may include a PSI semantics component 1225, a PDU session component 1230, a resource allocation component 1235, a filtering component 1240, an AF component 1245, a QoS or QoE component 1250, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support media session management in accordance with examples as disclosed herein. The PSI semantics component 1225 is capable of, configured to, or operable to support a means for communicating, in association with an establishment of a PDU session between a first device and a second device, a first communication of information associated with an interpretation of a PSI field of a PDU header of PDUs communicated between the first device and the second device. The PDU session component 1230 is capable of, configured to, or operable to support a means for communicating a second communication associated with providing one or more PDUs of one or more PDU sets from the first device to the second device in accordance with the interpretation of the PSI field.

In some examples, to support communicating the first communication of the information associated with the interpretation of the PSI field, the PSI semantics component 1225 is capable of, configured to, or operable to support a means for receiving the information associated with the interpretation of the PSI field via a message communicated between the first device and the second device.

In some examples, to support receiving the information associated with the interpretation of the PSI field via the message communicated between the first device and the second device, the PSI semantics component 1225 is capable of, configured to, or operable to support a means for intercepting, via a proxy-call session control function associated with the network entity, the information associated with the interpretation of the PSI field from the message communicated between the first device and the second device.

In some examples, the network entity intercepts the interpretation of the PSI field via the proxy-call session control function in accordance with a PDU session between the first device and the second device being associated with an Internet Protocol multimedia subsystem.

In some examples, to support communicating the first communication of the information associated with the interpretation of the PSI field, the PSI semantics component 1225 is capable of, configured to, or operable to support a means for receiving, from a media session handler entity associated with the first device or the second device, a message including the information associated with the interpretation of the PSI field.

In some examples, the interpretation of the PSI field is extracted by the media session handler entity associated with the first device or the second device in accordance with a PDU session between the first device and the second device being associated with WebRTC.

In some examples, to support communicating the first communication of the information associated with the interpretation of the PSI field, the PSI semantics component 1225 is capable of, configured to, or operable to support a means for receiving a first message including a request for the interpretation of the PSI field. In some examples, to support communicating the first communication of the information associated with the interpretation of the PSI field, the PSI semantics component 1225 is capable of, configured to, or operable to support a means for transmitting a second message including an acceptance or a modification of the interpretation of the PSI field, where communicating the second communication associated with providing the one or more PDUs is in accordance with the acceptance or the modification of the interpretation of the PSI field by the network entity.

In some examples, the first message is a PDU session modification request message. In some examples, the PDU session modification request message includes a field or a set of one or more bits indicative of the interpretation of the PSI field.

In some examples, the network entity is a core network entity.

In some examples, the resource allocation component 1235 is capable of, configured to, or operable to support a means for determining a resource allocation associated with the second communication in accordance with the interpretation of the PSI field.

In some examples, to support determining the resource allocation, the resource allocation component 1235 is capable of, configured to, or operable to support a means for re-configuring, via a policy control function associated with the network entity, a set of multiple PDU set QoS parameters associated with the PDU session.

In some examples, the resource allocation component 1235 is capable of, configured to, or operable to support a means for identifying, via a UPF associated with the network entity, a QoS flow in accordance with the interpretation of the PSI field, where the set of multiple PDU set QoS parameters is re-configured in association with identifying the QoS flow.

In some examples, the resource allocation component 1235 is capable of, configured to, or operable to support a means for mapping, via the policy control function, a traffic type to a set of QoS parameters in accordance with the interpretation of the PSI field, where the set of multiple PDU set QoS parameters is re-configured in association with the mapping of the traffic type to the set of QoS parameters. In some examples, the resource allocation component 1235 is capable of, configured to, or operable to support a means for transmitting, to one or more of a SMF, a UPF, or a radio access network component associated with the network entity, an indication of the mapping of the traffic type to the set of QoS parameters.

In some examples, to support determining the resource allocation, the resource allocation component 1235 is capable of, configured to, or operable to support a means for transmitting, to one or more of a SMF, a UPF, or a radio access network component associated with the network entity, the interpretation of the PSI field as an input for a determination of the resource allocation. In some examples, to support determining the resource allocation, the resource allocation component 1235 is capable of, configured to, or operable to support a means for determining, at one or more of the SMF, the UPF, or the radio access network component associated with the network entity, the resource allocation as an output of the determination.

In some examples, to support determining the resource allocation, the resource allocation component 1235 is capable of, configured to, or operable to support a means for accepting or modifying the interpretation of the PSI field. In some examples, to support determining the resource allocation, the resource allocation component 1235 is capable of, configured to, or operable to support a means for configuring one or more of a SMF, a UPF, or a radio access network component associated with the network entity in association with accepting or modifying the interpretation of the PSI field.

In some examples, the resource allocation component 1235 is capable of, configured to, or operable to support a means for transmitting, to one or both of the first device or the second device, second information associated with a resource allocation for a PDU session between the first device and the second device, where communicating the second communication associated with providing the one or more PDUs is in accordance with the resource allocation.

In some examples, the resource allocation indicates one or more first physical resources associated with the PDU session between the first device and the second device, one or more second physical resources for two or more network entities associated with providing the one or more PDUs from the first device to the second device, a first mapping between each PSI field value of a set of multiple PSI field values and a respective QoS flow, a second mapping between each PSI field value of the set of multiple PSI field values and a respective set of QoS parameters, a third mapping that associates two or more PSI field values of the set of multiple PSI field values as corresponding to PDU sets having a dependency relationship, or any combination thereof.

In some examples, to support communicating the first communication of the information associated with the interpretation of the PSI field, the PSI semantics component 1225 is capable of, configured to, or operable to support a means for transmitting a message including the information associated with the interpretation of the PSI field.

In some examples, to support transmitting the message, the AF component 1245 is capable of, configured to, or operable to support a means for transmitting, via an AF associated with the network entity, the message to an application at one or both of the first device or the second device in association with the interpretation of the PSI field indicating a mapping that associates each PSI field value of a set of multiple PSI field values to a respective traffic type.

In some examples, the message is transmitted in accordance with a request for an updated interpretation of the PSI field. In some examples, the request is received from a radio access network component associated with the network entity. In some examples, the request is received in accordance with a satisfaction of one or more conditions. In some examples, the message is transmitted in accordance with a satisfaction of one or more conditions. In some examples, the one or more conditions include one or both of a network congestion level satisfying a threshold network congestion level or a network load level satisfying a threshold network load level. In some examples, the one or more conditions include a PDU set error rate satisfying a threshold PDU set error rate or PDU set error rates for multiple traffic types being within a threshold proximity of each other.

In some examples, the multiple traffic types include a first traffic type associated with an I-frame of video data and a second traffic type associated with a P-frame of video data. In some examples, the interpretation of the PSI field indicates a prioritization of the I-frame of video data and a de-prioritization of the P-frame of video data by decreasing a first PSI field value that corresponds first PDU sets carrying the I-frame of video data and increasing a second PSI field value that corresponds to second PDU sets carrying the P-frame of video data.

In some examples, the QoS or QoE component 1250 is capable of, configured to, or operable to support a means for receiving second information associated with a QoS metric or a QoE metric, where the interpretation of the PSI field is transmitted in association with receiving one or both of the QoS metric or the QoE metric to the network entity.

In some examples, the QoS or QoE component 1250 is capable of, configured to, or operable to support a means for forwarding one or both of the QoS metric or the QoE metric to a policy control function associated with the network entity. In some examples, the PSI semantics component 1225 is capable of, configured to, or operable to support a means for generating the interpretation of the PSI field at the policy control function.

In some examples, to support transmitting the message, the PSI semantics component 1225 is capable of, configured to, or operable to support a means for transmitting the message to one or more of an application at one or both of the first device or the second device, a UPF, or a radio access network component associated with the network entity in association with the interpretation of the PSI field indicating a mapping that associates two or more PSI field values of a set of multiple PSI field values as corresponding to PDU sets having a dependency relationship.

In some examples, to support transmitting the message, the PSI semantics component 1225 is capable of, configured to, or operable to support a means for transmitting the message to one or both of a UPF or a radio access network component associated with the network entity in association with the interpretation of the PSI field indicating a mapping that associates each PSI field value of a set of multiple PSI field values to a respective set of QoS parameters.

In some examples, the interpretation of the PSI field indicates a mapping that associates each PSI field value of a set of multiple PSI field values to a respective traffic type. In some examples, in accordance with the mapping, a first PSI field value corresponds to a first traffic type and a second PSI field value corresponds to a second traffic type. In some examples, in accordance with the mapping, a first PSI field value corresponds to telemetry data, a second PSI field value corresponds to audio data, a third PSI field value corresponds to an I-frame of video data, and a fourth PSI field value corresponds to a P-frame of video data.

In some examples, the interpretation of the PSI field indicates a mapping that associates two or more PSI field values of a set of multiple PSI field values as corresponding to PDU sets having a dependency relationship. In some examples, in accordance with the mapping, a first PDU set associated with a first PSI field value and a second PDU set associated with a second PSI field value have a first dependency relationship. In some examples, the first dependency relationship indicates that the first PDU set depends on the second PDU set. In some examples, the first PDU set is associated with audio data and the second PDU set is associated with audio metadata data. In some examples, the first PDU set is associated with a P-frame of video data and the second PDU set is associated with an I-frame of video data.

In some examples, in accordance with the mapping, a third PDU set associated with a third PSI field value and a fourth PDU set associated with a fourth PSI field value have a second dependency relationship. In some examples, the second dependency relationship indicates that the third PDU set depends on the fourth PDU set.

In some examples, the interpretation of the PSI field indicates a mapping that associates each PSI field value of a set of multiple PSI field values to a respective set of communication parameters. In some examples, in accordance with the mapping, a first PSI field value corresponds to a first set of communication parameters and a second PSI field corresponds to a second set of communication parameters. In some examples, the respective set of communication parameters includes a respective set of QoS parameters. In some examples, in accordance with the mapping, a first PSI field value corresponds to a first set of QoS parameters, and a second PSI field value corresponds to a second set of QoS parameters. In some examples, the first set of QoS parameters includes a first PDU set delay budget and a first PDU set error rate and the second set of QoS parameters includes a second PDU set delay budget and a second PDU set error rate.

In some examples, to support communicating the second communication associated with providing the one or more PDUs, the PDU session component 1230 is capable of, configured to, or operable to support a means for obtaining a first PDU associated with a first PSI field value. In some examples, to support communicating the second communication associated with providing the one or more PDUs, the filtering component 1240 is capable of, configured to, or operable to support a means for filtering the first PDU in accordance with a packet filter that is based on the first PSI field value. In some examples, to support communicating the second communication associated with providing the one or more PDUs, the filtering component 1240 is capable of, configured to, or operable to support a means for determining a first Qos flow associated with the first PDU is defined based on the first PSI field value. In some examples, to support communicating the second communication associated with providing the one or more PDUs, the PDU session component 1230 is capable of, configured to, or operable to support a means for transmitting the first PDU in accordance with a set of communication parameters associated with the first QoS flow.

In some examples, the PDU session component 1230 is capable of, configured to, or operable to support a means for transmitting, in association with the establishment of the PDU session, second information associated with a mapping between each PDU set of a set of multiple PDU sets and a respective set of QoS parameters, where, in accordance with the mapping, a first PDU set of a first QoS flow is associated with a first set of QoS parameters and a second PDU set of the first QoS flow is associated with a second set of QoS parameters.

Additionally, or alternatively, the communications manager 1220 may support media session management in accordance with examples as disclosed herein. In some examples, the PDU session component 1230 is capable of, configured to, or operable to support a means for obtaining one or more PDUs in association with a PDU session between a first device and a second device. In some examples, the PDU session component 1230 is capable of, configured to, or operable to support a means for selecting a set of communication parameters for one or more PDUs associated in accordance with a media type (as indicated by a field value, such as a PSI field value) associated with the one or more PDUs. In some examples, the PDU session component 1230 is capable of, configured to, or operable to support a means for transmitting the one or more PDUs in accordance with the set of communication parameters.

In some examples, the PDU session component 1230 is capable of, configured to, or operable to support a means for obtaining the one or more PDUs from one of the first device or the second device or a UPF associated with the network entity. In some examples, the filtering component 1240 is capable of, configured to, or operable to support a means for filtering (e.g., grouping) the one or more PDUs to a QoS flow in accordance with a packet filter that is based on the PSI field value, where the set of communication parameters is selected in association with filtering (e.g., grouping) the one or more PDUs in accordance with the packet filter that is based on the PSI field value.

In some examples, the filtering component 1240 is capable of, configured to, or operable to support a means for determining a QoS flow associated with the one or more PDUs based on the packet filter, where the set of communication parameters is selected in association with determining the QoS flow associated with the one or more PDUs.

In some examples, the PSI field value and a set of Internet Protocol parameters jointly define the QoS flow in accordance with the packet filter. In some examples, a respective PSI field value and a respective set of Internet Protocol parameters jointly define a respective QoS flow in accordance with the packet filter. In some examples, the packet filter is an Internet Protocol packet filter or an Ethernet packet filter. In some examples, the set of communication parameters include a set of QoS parameters.

Additionally, or alternatively, the communications manager 1220 may support media session management in accordance with examples as disclosed herein. In some examples, the PDU session component 1230 is capable of, configured to, or operable to support a means for transmitting, in association with an establishment of a PDU session between a first device and a second device, information associated with a mapping between each protocol PDU set of a set of multiple PDU sets and a respective set of communication parameters. In some examples, the PDU session component 1230 is capable of, configured to, or operable to support a means for obtaining a first PDU set in accordance with the PDU session between the first device and the second device. In some examples, the PDU session component 1230 is capable of, configured to, or operable to support a means for selecting a first set of communication parameters for the first PDU set associated in accordance with the mapping. In some examples, the PDU session component 1230 is capable of, configured to, or operable to support a means for transmitting the first PDU set in accordance with the first set of communication parameters.

In some examples, the first PDU set is obtained from one of the first device or the second device or a UPF associated with the network entity.

In some examples, the PDU session component 1230 is capable of, configured to, or operable to support a means for obtaining a second PDU set in accordance with the PDU session between the first device and the second device. In some examples, the PDU session component 1230 is capable of, configured to, or operable to support a means for selecting a second set of communication parameters for the second PDU set in accordance with the mapping. In some examples, the PDU session component 1230 is capable of, configured to, or operable to support a means for transmitting the second PDU set in accordance with the second set of communication parameters.

In some examples, the first PDU set and the second PDU set are associated with a same QoS flow.

In some examples, the first PDU set is associated with a first traffic type (e.g., a first media type) and the second PDU set is associated with a second traffic type (e.g., a second media type). In some examples, the first traffic type is associated with an I-frame of video data and the second traffic type is associated with a P-frame of video data. In some examples, the first traffic type is associated with telemetry data and the second traffic type is associated with audio data. In some examples, the first traffic type is associated with audio data and the second traffic type is associated with audio metadata data.

In some examples, the first set of communication parameters include a first set of QoS parameters, and the second set of communication parameters include a second set of QoS parameters. In some examples, the first set of QoS parameters are associated with a first PDU set delay budget, a first PDU set error rate, and first PDU set integrated handling information and the second set of QoS parameters are associated with a second PDU set delay budget, a second PDU set error rate, and second PDU set integrated handling information.

In some examples, the first PDU set delay budget, the first PDU set error rate, and the first PDU set integrated handling information are different than the second PDU set delay budget, the second PDU set error rate, and the second PDU set integrated handling information, respectively, in association with the first PDU set being associated with a first PSI field value that is different than a second PSI field value associated with the second PDU set.

In some examples, the first PDU set delay budget, the first PDU set error rate, and the first PDU set integrated handling information are equal to the second PDU set delay budget, the second PDU set error rate, and the second PDU set integrated handling information, respectively, in association with the first PDU set being associated with a first PSI field value that is equal to a second PSI field value associated with the second PDU set.

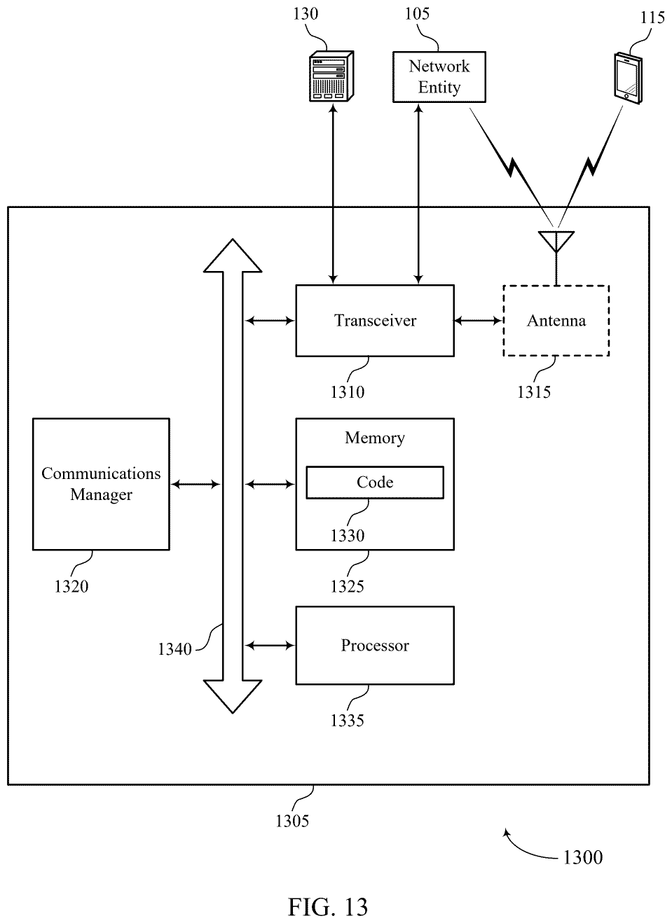

FIG. 13 shows a diagram of a system 1300 including a device 1305 that supports techniques for a configuration of PSI field semantics and QoS provisioning in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting techniques for a configuration of PSI field semantics and QoS provisioning). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support media session management in accordance with examples as disclosed herein. For example, the communications manager 1320 is capable of, configured to, or operable to support a means for communicating, in association with an establishment of a PDU session between a first device and a second device, a first communication of information associated with an interpretation of a PSI field of a PDU header of PDUs communicated between the first device and the second device. The communications manager 1320 is capable of, configured to, or operable to support a means for communicating a second communication associated with providing one or more PDUs of one or more PDU sets from the first device to the second device in accordance with the interpretation of the PSI field.

Additionally, or alternatively, the communications manager 1320 may support media session management in accordance with examples as disclosed herein. For example, the communications manager 1320 is capable of, configured to, or operable to support a means for obtaining one or more PDUs in association with a PDU session between a first device and a second device. The communications manager 1320 is capable of, configured to, or operable to support a means for selecting a set of communication parameters for one or more PDUs associated in accordance with a media type (as indicated by a field value, such as a PSI field value) associated with the one or more PDUs. The communications manager 1320 is capable of, configured to, or operable to support a means for transmitting the one or more PDUs in accordance with the set of communication parameters.

Additionally, or alternatively, the communications manager 1320 may support media session management in accordance with examples as disclosed herein. For example, the communications manager 1320 is capable of, configured to, or operable to support a means for transmitting, in association with an establishment of a PDU session between a first device and a second device, information associated with a mapping between each protocol PDU set of a set of multiple PDU sets and a respective set of communication parameters. The communications manager 1320 is capable of, configured to, or operable to support a means for obtaining a first PDU set in accordance with the PDU session between the first device and the second device. The communications manager 1320 is capable of, configured to, or operable to support a means for selecting a first set of communication parameters for the first PDU set associated in accordance with the mapping. The communications manager 1320 is capable of, configured to, or operable to support a means for transmitting the first PDU set in accordance with the first set of communication parameters.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of techniques for a configuration of PSI field semantics and QoS provisioning as described herein, or the at least one processor 1335 and the at least one memory 1325 may be otherwise configured to, individually or collectively, perform or support such operations.

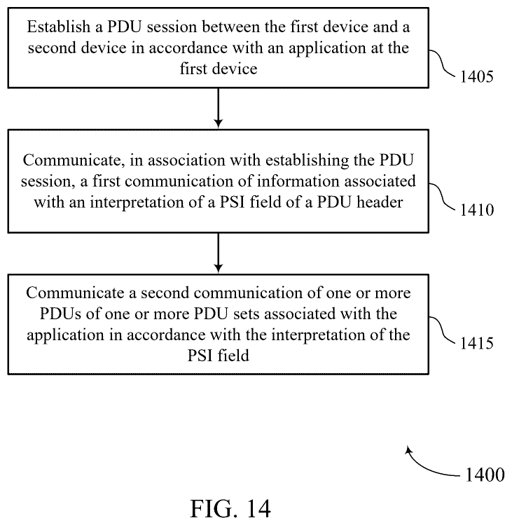

FIG. 14 shows a flowchart illustrating a method 1400 that supports techniques for a configuration of PSI field semantics and QoS provisioning in accordance with one or more aspects of the present disclosure. The operations of the method 1400 may be implemented by a UE or its components as described herein. For example, the operations of the method 1400 may be performed by a UE 115 as described with reference to FIGS. 1-9. In some examples, a UE may execute a set of instructions to control the functional elements of the UE to perform the described functions. Additionally, or alternatively, the UE may perform aspects of the described functions using special-purpose hardware.

At 1405, the method may include establishing a PDU session between the first device and a second device in accordance with an application at the first device. The operations of 1405 may be performed in accordance with examples as disclosed herein. In some examples, aspects of the operations of 1405 may be performed by a PDU session component 825 as described with reference to FIG. 8.

At 1410, the method may include communicating, in association with establishing the PDU session, a first communication of information associated with an interpretation of a PSI field of a PDU header. The operations of 1410 may be performed in accordance with examples as disclosed herein. In some examples, aspects of the operations of 1410 may be performed by a PSI semantics component 830 as described with reference to FIG. 8.

At 1415, the method may include communicating a second communication of one or more PDUs of one or more PDU sets associated with the application in accordance with the interpretation of the PSI field. The operations of 1415 may be performed in accordance with examples as disclosed herein. In some examples, aspects of the operations of 1415 may be performed by a PSI semantics component 830 as described with reference to FIG. 8.

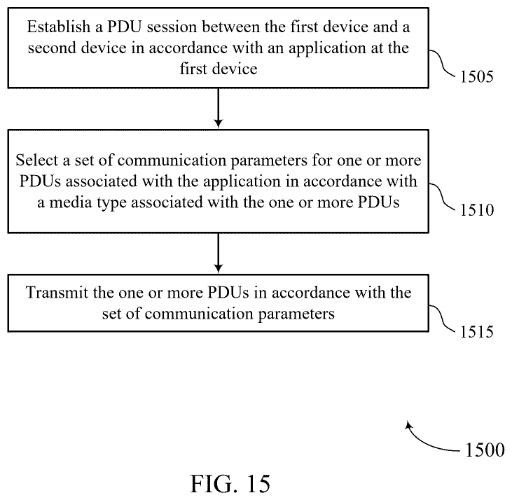

FIG. 15 shows a flowchart illustrating a method 1500 that supports techniques for a configuration of PSI field semantics and QoS provisioning in accordance with one or more aspects of the present disclosure. The operations of the method 1500 may be implemented by a UE or its components as described herein. For example, the operations of the method 1500 may be performed by a UE 115 as described with reference to FIGS. 1-9. In some examples, a UE may execute a set of instructions to control the functional elements of the UE to perform the described functions. Additionally, or alternatively, the UE may perform aspects of the described functions using special-purpose hardware.

At 1505, the method may include establishing a PDU session between the first device and a second device in accordance with an application at the first device. The operations of 1505 may be performed in accordance with examples as disclosed herein. In some examples, aspects of the operations of 1505 may be performed by a PDU session component 825 as described with reference to FIG. 8.

At 1510, the method may include selecting a set of communication parameters for one or more PDUs associated with the application in accordance with a media type associated with the one or more PDUs. The operations of 1510 may be performed in accordance with examples as disclosed herein. In some examples, aspects of the operations of 1510 may be performed by a PDU session component 825 as described with reference to FIG. 8.

At 1515, the method may include transmitting the one or more PDUs in accordance with the set of communication parameters. The operations of 1515 may be performed in accordance with examples as disclosed herein. In some examples, aspects of the operations of 1515 may be performed by a PDU session component 825 as described with reference to FIG. 8.

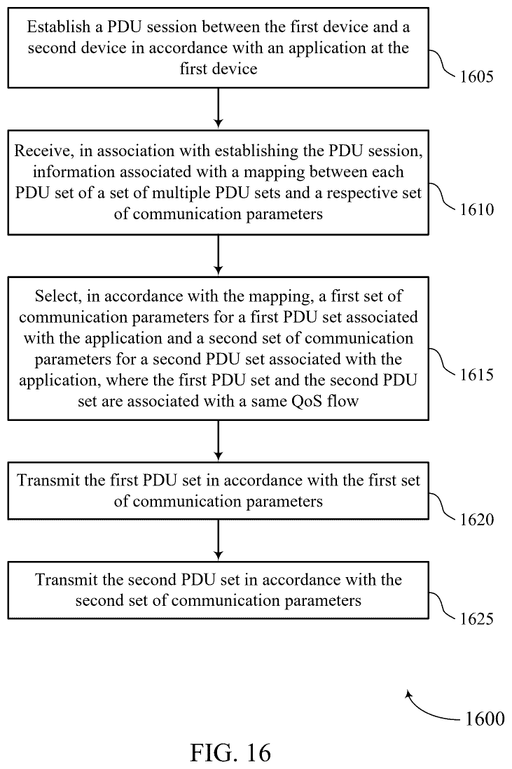

FIG. 16 shows a flowchart illustrating a method 1600 that supports techniques for a configuration of PSI field semantics and QoS provisioning in accordance with one or more aspects of the present disclosure. The operations of the method 1600 may be implemented by a UE or its components as described herein. For example, the operations of the method 1600 may be performed by a UE 115 as described with reference to FIGS. 1-9. In some examples, a UE may execute a set of instructions to control the functional elements of the UE to perform the described functions. Additionally, or alternatively, the UE may perform aspects of the described functions using special-purpose hardware.

At 1605, the method may include establishing a PDU session between the first device and a second device in accordance with an application at the first device. The operations of 1605 may be performed in accordance with examples as disclosed herein. In some examples, aspects of the operations of 1605 may be performed by a PDU session component 825 as described with reference to FIG. 8.

At 1610, the method may include receiving, in association with establishing the PDU session, information associated with a mapping between each PDU set of a set of multiple PDU sets and a respective set of communication parameters. The operations of 1610 may be performed in accordance with examples as disclosed herein. In some examples, aspects of the operations of 1610 may be performed by a PDU session component 825 as described with reference to FIG. 8.

At 1615, the method may include selecting, in accordance with the mapping, a first set of communication parameters for a first PDU set associated with the application and a second set of communication parameters for a second PDU set associated with the application, where the first PDU set and the second PDU set are associated with a same QoS flow. The operations of 1615 may be performed in accordance with examples as disclosed herein. In some examples, aspects of the operations of 1615 may be performed by a PDU session component 825 as described with reference to FIG. 8.

At 1620, the method may include transmitting the first PDU set in accordance with the first set of communication parameters. The operations of 1620 may be performed in accordance with examples as disclosed herein. In some examples, aspects of the operations of 1620 may be performed by a PDU session component 825 as described with reference to FIG. 8.

At 1625, the method may include transmitting the second PDU set in accordance with the second set of communication parameters. The operations of 1625 may be performed in accordance with examples as disclosed herein. In some examples, aspects of the operations of 1625 may be performed by a PDU session component 825 as described with reference to FIG. 8.

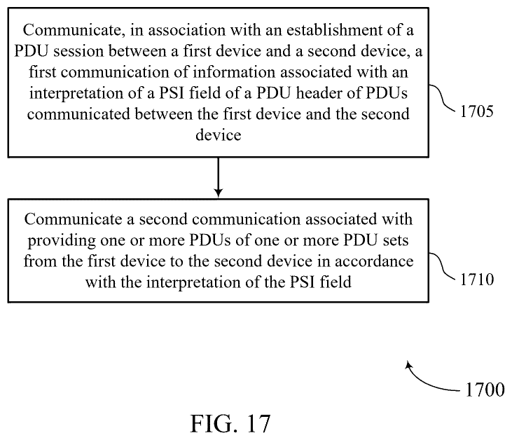

FIG. 17 shows a flowchart illustrating a method 1700 that supports techniques for a configuration of PSI field semantics and QoS provisioning in accordance with one or more aspects of the present disclosure. The operations of the method 1700 may be implemented by a network entity or its components as described herein. For example, the operations of the method 1700 may be performed by a network entity as described with reference to FIGS. 1-5 and 10-13. In some examples, a network entity may execute a set of instructions to control the functional elements of the network entity to perform the described functions. Additionally, or alternatively, the network entity may perform aspects of the described functions using special-purpose hardware.

At 1705, the method may include communicating, in association with an establishment of a PDU session between a first device and a second device, a first communication of information associated with an interpretation of a PSI field of a PDU header of PDUs communicated between the first device and the second device. The operations of 1705 may be performed in accordance with examples as disclosed herein. In some examples, aspects of the operations of 1705 may be performed by a PSI semantics component 1225 as described with reference to FIG. 12.

At 1710, the method may include communicating a second communication associated with providing one or more PDUs of one or more PDU sets from the first device to the second device in accordance with the interpretation of the PSI field. The operations of 1710 may be performed in accordance with examples as disclosed herein. In some examples, aspects of the operations of 1710 may be performed by a PDU session component 1230 as described with reference to FIG. 12.

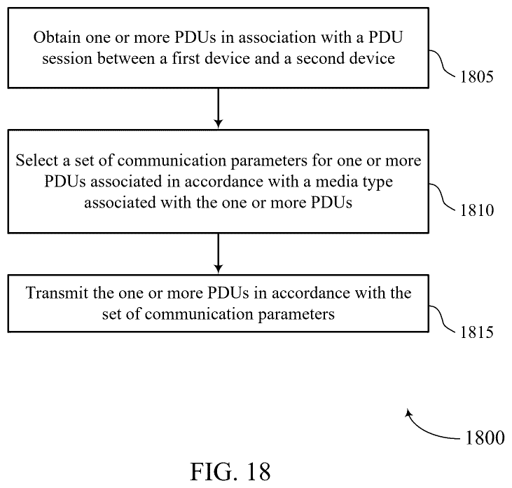

FIG. 18 shows a flowchart illustrating a method 1800 that supports techniques for a configuration of PSI field semantics and QoS provisioning in accordance with one or more aspects of the present disclosure. The operations of the method 1800 may be implemented by a network entity or its components as described herein. For example, the operations of the method 1800 may be performed by a network entity as described with reference to FIGS. 1-5 and 10-13. In some examples, a network entity may execute a set of instructions to control the functional elements of the network entity to perform the described functions. Additionally, or alternatively, the network entity may perform aspects of the described functions using special-purpose hardware.

At 1805, the method may include obtaining one or more PDUs in association with a PDU session between a first device and a second device. The operations of 1805 may be performed in accordance with examples as disclosed herein. In some examples, aspects of the operations of 1805 may be performed by a PDU session component 1230 as described with reference to FIG. 12.

At 1810, the method may include selecting a set of communication parameters for one or more PDUs associated in accordance with a media type associated with the one or more PDUs. The operations of 1810 may be performed in accordance with examples as disclosed herein. In some examples, aspects of the operations of 1810 may be performed by a PDU session component 1230 as described with reference to FIG. 12.

At 1815, the method may include transmitting the one or more PDUs in accordance with the set of communication parameters. The operations of 1815 may be performed in accordance with examples as disclosed herein. In some examples, aspects of the operations of 1815 may be performed by a PDU session component 1230 as described with reference to FIG. 12.

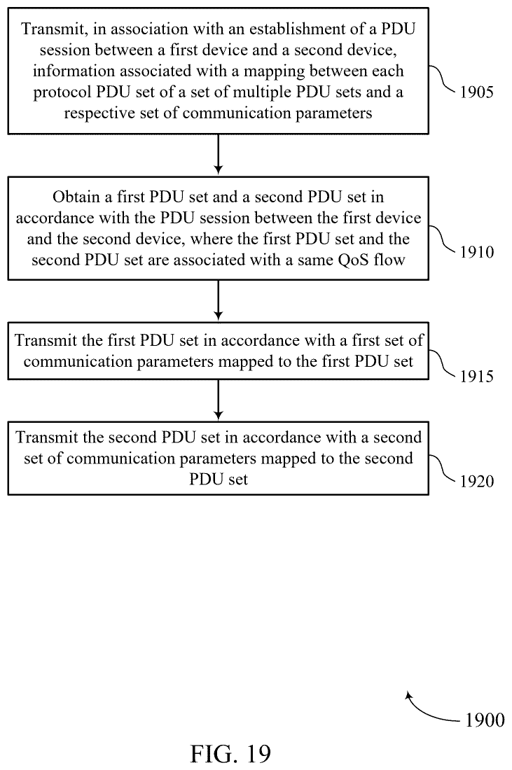

FIG. 19 shows a flowchart illustrating a method 1900 that supports techniques for a configuration of PSI field semantics and QoS provisioning in accordance with one or more aspects of the present disclosure. The operations of the method 1900 may be implemented by a network entity or its components as described herein. For example, the operations of the method 1900 may be performed by a network entity as described with reference to FIGS. 1-5 and 10-13. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, in association with an establishment of a PDU session between a first device and a second device, information associated with a mapping between each protocol PDU set of a set of multiple PDU sets and a respective set of communication parameters. The operations of 1905 may be performed in accordance with examples as disclosed herein. In some examples, aspects of the operations of 1905 may be performed by a PDU session component 1230 as described with reference to FIG. 12.

At 1910, the method may include obtaining a first PDU set and a second PDU set in accordance with the PDU session between the first device and the second device, where the first PDU set and the second PDU set are associated with a same QoS flow. The operations of 1910 may be performed in accordance with examples as disclosed herein. In some examples, aspects of the operations of 1910 may be performed by a PDU session component 1230 as described with reference to FIG. 12.

At 1915, the method may include transmitting the first PDU set in accordance with a first set of communication parameters mapped to the first PDU set. The operations of 1915 may be performed in accordance with examples as disclosed herein. In some examples, aspects of the operations of 1915 may be performed by a PDU session component 1230 as described with reference to FIG. 12.

At 1920, the method may include transmitting the second PDU set in accordance with a second set of communication parameters mapped to the second PDU set. The operations of 1920 may be performed in accordance with examples as disclosed herein. In some examples, aspects of the operations of 1920 may be performed by a PDU session component 1230 as described with reference to FIG. 12.

The following provides an overview of aspects of the present disclosure:

Aspect 1: A method for media session management at a first device, comprising: establishing a PDU session between the first device and a second device in accordance with an application at the first device; communicating, in association with establishing the PDU session, a first communication of information associated with an interpretation of a PSI field of a PDU header; and communicating a second communication of one or more PDUs of one or more PDU sets associated with the application in accordance with the interpretation of the PSI field.

Aspect 2: The method of aspect 1, wherein communicating the first communication of the information associated with the interpretation of the PSI field comprises: transmitting or receiving, to or from the second device, a message comprising the information associated with the interpretation of the PSI field.

Aspect 3: The method of aspect 2, further comprising: extracting, via a media session handler associated with the first device, the interpretation of the PSI field; and transmitting the information associated with the interpretation of the PSI field to a network entity, wherein communicating the second communication of the one or more PDUs is in association with transmitting the information associated with the interpretation of the PSI field to the network entity.

Aspect 4: The method of aspect 3, wherein the network entity is an AF, and the first device extracts the interpretation of the PSI field via the media session handler in accordance with the PDU session being associated with WebRTC.

Aspect 5: The method of any of aspects 1 through 4, wherein communicating the first communication of the information associated with the interpretation of the PSI field comprises: transmitting, to a network entity, a first message comprising a request for the interpretation of the PSI field; and receiving, from the network entity, a second message comprising an acceptance or a modification of the interpretation of the PSI field requested by the first device, wherein communicating the second communication of the one or more PDUs is in accordance with the acceptance or the modification of the interpretation of the PSI field by the network entity.

Aspect 6: The method of aspect 5, wherein the first message is a PDU session modification request message, and the PDU session modification request message comprises a field or a set of one or more bits indicative of the interpretation of the PSI field requested by the first device.

Aspect 7: The method of any of aspects 5 through 6, wherein the network entity is a core network entity.

Aspect 8: The method of any of aspects 1 through 7, further comprising: receiving second information associated with a resource allocation for the PDU session between the first device and the second device, wherein communicating the second communication of the one or more PDUs is in accordance with the resource allocation.

Aspect 9: The method of aspect 8, wherein the resource allocation indicates one or more physical resources associated with the PDU session, a first mapping between each PSI field value of a plurality of PSI field values and a respective Qos flow, a second mapping between each PSI field value of the plurality of PSI field values and a respective set of QoS parameters, a third mapping that associates two or more PSI field values of the plurality of PSI field values as corresponding to PDU sets having a dependency relationship, or any combination thereof.

Aspect 10: The method of any of aspects 8 through 9, wherein the resource allocation is received from a network entity.

Aspect 11: The method of any of aspects 1 through 10, wherein communicating the first communication of the information associated with the interpretation of the PSI field comprises: receiving a message comprising the information associated with the interpretation of the PSI field from a network entity.

Aspect 12: The method of aspect 11, wherein the message is received from the network entity in accordance with a satisfaction of one or more conditions.

Aspect 13: The method of aspect 12, wherein the one or more conditions comprise one or both of a network congestion level satisfying a threshold network congestion level or a network load level satisfying a threshold network load level.

Aspect 14: The method of any of aspects 12 through 13, wherein the one or more conditions comprise a PDU set error rate satisfying a threshold PDU set error rate or PDU set error rates for multiple traffic types being within a threshold proximity of each other.

Aspect 15: The method of aspect 14, wherein the multiple traffic types include a first traffic type associated with an I-frame of video data and a second traffic type associated with a P-frame of video data, and the interpretation of the PSI field indicates a prioritization of the I-frame of video data and a de-prioritization of the P-frame of video data by decreasing a first PSI field value that corresponds first PDU sets carrying the I-frame of video data and increasing a second PSI field value that corresponds to second PDU sets carrying the P-frame of video data.

Aspect 16: The method of any of aspects 11 through 15, further comprising: transmitting second information associated with a QoS metric or a QoE metric to the network entity, wherein the interpretation of the PSI field is received from the network entity in association with transmitting one or both of the QoS metric or the QoE metric to the network entity.

Aspect 17: The method of aspect 16, wherein the network entity forwards one or both of the QoS metric or the QoE metric to a policy control function associated with the network entity, and the policy control function generates the interpretation of the PSI field.

Aspect 18: The method of any of aspects 1 through 17, wherein the interpretation of the PSI field indicates a mapping that associates each PSI field value of a plurality of PSI field values to a respective traffic type.

Aspect 19: The method of aspect 18, wherein in accordance with the mapping, a first PSI field value corresponds to a first traffic type and a second PSI field value corresponds to a second traffic type.

Aspect 20: The method of any of aspects 18 through 19, wherein in accordance with the mapping, a first PSI field value corresponds to telemetry data, a second PSI field value corresponds to audio data, a third PSI field value corresponds to an I-frame of video data, and a fourth PSI field value corresponds to a P-frame of video data.

Aspect 21: The method of any of aspects 1 through 20, wherein the interpretation of the PSI field indicates a mapping that associates two or more PSI field values of a plurality of PSI field values as corresponding to PDU sets having a dependency relationship.

Aspect 22: The method of aspect 21, wherein in accordance with the mapping, a first PDU set associated with a first PSI field value and a second PDU set associated with a second PSI field value have a first dependency relationship.

Aspect 23: The method of aspect 22, wherein the first dependency relationship indicates that the first PDU set depends on the second PDU set.

Aspect 24: The method of aspect 23, wherein the first PDU set is associated with audio data and the second PDU set is associated with audio metadata data.

Aspect 25: The method of any of aspects 23 through 24, wherein the first PDU set is associated with a P-frame of video data and the second PDU set is associated with an I-frame of video data.

Aspect 26: The method of any of aspects 22 through 25, wherein in accordance with the mapping, a third PDU set associated with a third PSI field value and a fourth PDU set associated with a fourth PSI field value have a second dependency relationship, and the second dependency relationship indicates that the third PDU set depends on the fourth PDU set.

Aspect 27: The method of any of aspects 1 through 26, wherein the interpretation of the PSI field indicates a mapping that associates each PSI field value of a plurality of PSI field values to a respective set of communication parameters.

Aspect 28: The method of aspect 27, wherein in accordance with the mapping, a first PSI field value corresponds to a first set of communication parameters and a second PSI field corresponds to a second set of communication parameters.

Aspect 29: The method of any of aspects 27 through 28, wherein the respective set of communication parameters comprises a respective set of QoS parameters.

Aspect 30: The method of aspect 29, wherein in accordance with the mapping, a first PSI field value corresponds to a first set of QoS parameters, and a second PSI field value corresponds to a second set of QoS parameters.

Aspect 31: The method of aspect 30, wherein the first set of QoS parameters comprises a first PDU set delay budget and a first PDU set error rate and the second set of QoS parameters comprises a second PDU set delay budget and a second PDU set error rate.

Aspect 32: The method of any of aspects 1 through 31, wherein communicating the second communication of the one or more PDUs comprises: obtaining a first PDU from the application; filtering the first PDU in accordance with a packet filter that is based at least in part on a first PSI field value associated with the first PDU; determining a first QoS flow associated with the first PDU based at least in part on the packet filter; and transmitting the first PDU in accordance with a set of QoS parameters associated with the first QoS flow.

Aspect 33: The method of any of aspects 1 through 32, further comprising: receiving, in association with establishing the PDU session, second information associated with a mapping between each PDU set of a plurality of PDU sets and a respective set of QoS parameters, wherein, in accordance with the mapping, a first PDU set of a first QoS flow is associated with a first set of QoS parameters and a second PDU set of the first QoS flow is associated with a second set of QoS parameters.

Aspect 34: A method for media session management at a first device, comprising: establishing a PDU session between the first device and a second device in accordance with an application at the first device; selecting a set of communication parameters for one or more PDUs associated with the application in accordance with a media type (as indicated by a field value, such as a PSI field value) associated with the one or more PDUs; and transmitting the one or more PDUs in accordance with the set of communication parameters.

Aspect 35: The method of aspect 34, further comprising: obtaining the one or more PDUs from the application; and filtering (e.g., grouping) the one or more PDUs to a QoS flow in accordance with a packet filter that is based at least in part on the PSI field value, wherein the set of communication parameters is selected in association with filtering (e.g., grouping) the one or more PDUs in accordance with the packet filter that is based at least in part on the PSI field value.

Aspect 36: The method of aspect 35, further comprising: determining a QoS flow associated with the one or more PDUs based at least in part on the packet filter, wherein the set of communication parameters is selected in association with determining the QoS flow associated with the one or more PDUs.

Aspect 37: The method of aspect 36, wherein the PSI field value and a set of Internet Protocol parameters jointly define the QoS flow in accordance with the packet filter.

Aspect 38: The method of any of aspects 36 through 37, wherein a respective PSI field value and a respective set of Internet Protocol parameters jointly define a respective QoS flow in accordance with the packet filter.

Aspect 39: The method of any of aspects 35 through 38, wherein the packet filter is an Internet Protocol packet filter or an Ethernet packet filter.

Aspect 40: The method of any of aspects 34 through 39, wherein the set of communication parameters comprise a set of QoS parameters.

Aspect 41: A method for media session management at a first device, comprising: establishing a PDU session between the first device and a second device in accordance with an application at the first device; receiving, in association with establishing the PDU session, information associated with a mapping between each PDU set of a plurality of PDU sets and a respective set of communication parameters; selecting a first set of communication parameters for a first PDU set associated with the application in accordance with the mapping; and transmitting the first PDU set in accordance with the first set of communication parameters.

Aspect 42: The method of aspect 41, further comprising: selecting a second set of communication parameters for a second PDU set associated with the application in accordance with the mapping; and transmitting the second PDU set in accordance with the second set of communication parameters.

Aspect 43: The method of aspect 42, wherein the first PDU set and the second PDU set are associated with a same QoS flow.

Aspect 44: The method of any of aspects 42 through 43, wherein the first PDU set is associated with a first traffic type and the second PDU set is associated with a second traffic type.

Aspect 45: The method of aspect 44, wherein the first traffic type is associated with an I-frame of video data and the second traffic type is associated with a P-frame of video data.

Aspect 46: The method of any of aspects 44 through 45, wherein the first traffic type is associated with telemetry data and the second traffic type is associated with audio data.

Aspect 47: The method of any of aspects 44 through 46, wherein the first traffic type is associated with audio data and the second traffic type is associated with audio metadata data.

Aspect 48: The method of any of aspects 42 through 47, wherein the first set of communication parameters comprise a first set of QoS parameters, and the second set of communication parameters comprise a second set of QoS parameters.

Aspect 49: The method of aspect 48, wherein the first set of QoS parameters are associated with a first PDU set delay budget, a first PDU set error rate, and first PDU set integrated handling information and the second set of QoS parameters are associated with a second PDU set delay budget, a second PDU set error rate, and second PDU set integrated handling information.

Aspect 50: The method of aspect 49, wherein the first PDU set delay budget, the first PDU set error rate, and the first PDU set integrated handling information are different than the second PDU set delay budget, the second PDU set error rate, and the second PDU set integrated handling information, respectively, in association with the first PDU set being associated with a first PSI field value that is different than a second PSI field value associated with the second PDU set.

Aspect 51: The method of any of aspects 49 through 50, wherein the first PDU set delay budget, the first PDU set error rate, and the first PDU set integrated handling information are equal to the second PDU set delay budget, the second PDU set error rate, and the second PDU set integrated handling information, respectively, in association with the first PDU set being associated with a first PSI field value that is equal to a second PSI field value associated with the second PDU set.

Aspect 52: A method for media session management at a network entity, comprising: communicating, in association with an establishment of a PDU session between a first device and a second device, a first communication of information associated with an interpretation of a PSI field of a PDU header of PDUs communicated between the first device and the second device; and communicating a second communication associated with providing one or more PDUs of one or more PDU sets from the first device to the second device in accordance with the interpretation of the PSI field.

Aspect 53: The method of aspect 52, wherein communicating the first communication of the information associated with the interpretation of the PSI field comprises: receiving the information associated with the interpretation of the PSI field via a message communicated between the first device and the second device.

Aspect 54: The method of aspect 53, wherein receiving the information associated with the interpretation of the PSI field via the message communicated between the first device and the second device comprises: intercepting, via a proxy-call session control function associated with the network entity, the information associated with the interpretation of the PSI field from the message communicated between the first device and the second device.

Aspect 55: The method of aspect 54, wherein the network entity intercepts the interpretation of the PSI field via the proxy-call session control function in accordance with a PDU session between the first device and the second device being associated with an Internet Protocol multimedia subsystem.

Aspect 56: The method of any of aspects 52 through 55, wherein communicating the first communication of the information associated with the interpretation of the PSI field comprises: receiving, from a media session handler entity associated with the first device or the second device, a message comprising the information associated with the interpretation of the PSI field.

Aspect 57: The method of aspect 56, wherein the interpretation of the PSI field is extracted by the media session handler entity associated with the first device or the second device in accordance with a PDU session between the first device and the second device being associated with WebRTC.

Aspect 58: The method of any of aspects 52 through 57, wherein communicating the first communication of the information associated with the interpretation of the PSI field comprises: receiving a first message comprising a request for the interpretation of the PSI field; and transmitting a second message comprising an acceptance or a modification of the interpretation of the PSI field, wherein communicating the second communication associated with providing the one or more PDUs is in accordance with the acceptance or the modification of the interpretation of the PSI field by the network entity.

Aspect 59: The method of aspect 58, wherein the first message is a PDU session modification request message, and the PDU session modification request message comprises a field or a set of one or more bits indicative of the interpretation of the PSI field.

Aspect 60: The method of any of aspects 58 through 59, wherein the network entity is a core network entity.

Aspect 61: The method of any of aspects 52 through 60, further comprising: determining a resource allocation associated with the second communication in accordance with the interpretation of the PSI field.

Aspect 62: The method of aspect 61, wherein determining the resource allocation comprises: re-configuring, via a policy control function associated with the network entity, a plurality of PDU set QoS parameters associated with the PDU session.

Aspect 63: The method of aspect 62, further comprising: identifying, via a UPF associated with the network entity, a QoS flow in accordance with the interpretation of the PSI field, wherein the plurality of PDU set QoS parameters is re-configured in association with identifying the QoS flow.

Aspect 64: The method of any of aspects 62 through 63, further comprising: mapping, via the policy control function, a traffic type to a set of QoS parameters in accordance with the interpretation of the PSI field, wherein the plurality of PDU set QoS parameters is re-configured in association with the mapping of the traffic type to the set of QoS parameters; and transmitting, to one or more of a SMF, a UPF, or a radio access network component associated with the network entity, an indication of the mapping of the traffic type to the set of QoS parameters.

Aspect 65: The method of any of aspects 61 through 64, wherein determining the resource allocation comprises: transmitting, to one or more of a SMF, a UPF, or a radio access network component associated with the network entity, the interpretation of the PSI field as an input for a determination of the resource allocation; and determining, at one or more of the SMF, the UPF, or the radio access network component associated with the network entity, the resource allocation as an output of the determination.

Aspect 66: The method of any of aspects 61 through 65, wherein determining the resource allocation comprises: accepting or modifying the interpretation of the PSI field; and configuring one or more of a SMF, a UPF, or a radio access network component associated with the network entity in association with accepting or modifying the interpretation of the PSI field.

Aspect 67: The method of any of aspects 61 through 66, further comprising: transmitting, to one or both of the first device or the second device, second information associated with a resource allocation for a PDU session between the first device and the second device, wherein communicating the second communication associated with providing the one or more PDUs is in accordance with the resource allocation.

Aspect 68: The method of any of aspects 61 through 67, wherein the resource allocation indicates one or more first physical resources associated with the PDU session between the first device and the second device, one or more second physical resources for two or more network entities associated with providing the one or more PDUs from the first device to the second device, a first mapping between each PSI field value of a plurality of PSI field values and a respective QoS flow, a second mapping between each PSI field value of the plurality of PSI field values and a respective set of QoS parameters, a third mapping that associates two or more PSI field values of the plurality of PSI field values as corresponding to PDU sets having a dependency relationship, or any combination thereof.

Aspect 69: The method of any of aspects 52 through 68, wherein communicating the first communication of the information associated with the interpretation of the PSI field comprises: transmitting a message comprising the information associated with the interpretation of the PSI field.

Aspect 70: The method of aspect 69, wherein transmitting the message comprises: transmitting, via an AF associated with the network entity, the message to an application at one or both of the first device or the second device in association with the interpretation of the PSI field indicating a mapping that associates each PSI field value of a plurality of PSI field values to a respective traffic type.

Aspect 71: The method of aspect 70, wherein the message is transmitted in accordance with a request for an updated interpretation of the PSI field.

Aspect 72: The method of aspect 71, wherein the request is received from a radio access network component associated with the network entity, and the request is received in accordance with a satisfaction of one or more conditions.

Aspect 73: The method of any of aspects 70 through 72, wherein the message is transmitted in accordance with a satisfaction of one or more conditions.

Aspect 74: The method of aspect 73, wherein the one or more conditions comprise one or both of a network congestion level satisfying a threshold network congestion level or a network load level satisfying a threshold network load level.

Aspect 75: The method of any of aspects 73 through 74, wherein the one or more conditions comprise a PDU set error rate satisfying a threshold PDU set error rate or PDU set error rates for multiple traffic types being within a threshold proximity of each other.

Aspect 76: The method of aspect 75, wherein the multiple traffic types include a first traffic type associated with an I-frame of video data and a second traffic type associated with a P-frame of video data, and the interpretation of the PSI field indicates a prioritization of the I-frame of video data and a de-prioritization of the P-frame of video data by decreasing a first PSI field value that corresponds first PDU sets carrying the I-frame of video data and increasing a second PSI field value that corresponds to second PDU sets carrying the P-frame of video data.

Aspect 77: The method of any of aspects 70 through 76, further comprising: receiving second information associated with a QoS metric or a QoE metric, wherein the interpretation of the PSI field is transmitted in association with receiving one or both of the QoS metric or the QoE metric to the network entity.

Aspect 78: The method of aspect 77, further comprising: forwarding one or both of the QoS metric or the QoE metric to a policy control function associated with the network entity; and generating the interpretation of the PSI field at the policy control function.

Aspect 79: The method of any of aspects 69 through 78, wherein transmitting the message comprises: transmitting the message to one or more of an application at one or both of the first device or the second device, a UPF, or a radio access network component associated with the network entity in association with the interpretation of the PSI field indicating a mapping that associates two or more PSI field values of a plurality of PSI field values as corresponding to PDU sets having a dependency relationship.

Aspect 80: The method of any of aspects 69 through 79, wherein transmitting the message comprises: transmitting the message to one or both of a UPF or a radio access network component associated with the network entity in association with the interpretation of the PSI field indicating a mapping that associates each PSI field value of a plurality of PSI field values to a respective set of QoS parameters.

Aspect 81: The method of any of aspects 52 through 80, wherein the interpretation of the PSI field indicates a mapping that associates each PSI field value of a plurality of PSI field values to a respective traffic type.

Aspect 82: The method of aspect 81, wherein in accordance with the mapping, a first PSI field value corresponds to a first traffic type and a second PSI field value corresponds to a second traffic type.

Aspect 83: The method of any of aspects 81 through 82, wherein in accordance with the mapping, a first PSI field value corresponds to telemetry data, a second PSI field value corresponds to audio data, a third PSI field value corresponds to an I-frame of video data, and a fourth PSI field value corresponds to a P-frame of video data.

Aspect 84: The method of any of aspects 52 through 83, wherein the interpretation of the PSI field indicates a mapping that associates two or more PSI field values of a plurality of PSI field values as corresponding to PDU sets having a dependency relationship.

Aspect 85: The method of aspect 84, wherein in accordance with the mapping, a first PDU set associated with a first PSI field value and a second PDU set associated with a second PSI field value have a first dependency relationship.

Aspect 86: The method of aspect 85, wherein the first dependency relationship indicates that the first PDU set depends on the second PDU set.

Aspect 87: The method of aspect 86, wherein the first PDU set is associated with audio data and the second PDU set is associated with audio metadata data.

Aspect 88: The method of any of aspects 86 through 87, wherein the first PDU set is associated with a P-frame of video data and the second PDU set is associated with an I-frame of video data.

Aspect 89: The method of any of aspects 85 through 88, wherein in accordance with the mapping, a third PDU set associated with a third PSI field value and a fourth PDU set associated with a fourth PSI field value have a second dependency relationship, and the second dependency relationship indicates that the third PDU set depends on the fourth PDU set.

Aspect 90: The method of any of aspects 52 through 89, wherein the interpretation of the PSI field indicates a mapping that associates each PSI field value of a plurality of PSI field values to a respective set of communication parameters.

Aspect 91: The method of aspect 90, wherein in accordance with the mapping, a first PSI field value corresponds to a first set of communication parameters and a second PSI field corresponds to a second set of communication parameters.

Aspect 92: The method of any of aspects 90 through 91, wherein the respective set of communication parameters comprises a respective set of QoS parameters.

Aspect 93: The method of aspect 92, wherein in accordance with the mapping, a first PSI field value corresponds to a first set of QoS parameters and a second PSI field value corresponds to a second set of QoS parameters.

Aspect 94: The method of aspect 93, wherein the first set of QoS parameters comprises a first PDU set delay budget and a first PDU set error rate and the second set of QoS parameters comprises a second PDU set delay budget and a second PDU set error rate.

Aspect 95: The method of any of aspects 52 through 94, wherein communicating the second communication associated with providing the one or more PDUs comprises: obtaining a first PDU associated with a first PSI field value; filtering the first PDU in accordance with a packet filter that is based at least in part on the first PSI field value; determining a first QoS flow associated with the first PDU is defined based at least in part on the first PSI field value; and transmitting the first PDU in accordance with a set of communication parameters associated with the first QoS flow.

Aspect 96: The method of any of aspects 52 through 95, further comprising: transmitting, in association with the establishment of the PDU session, second information associated with a mapping between each PDU set of a plurality of PDU sets and a respective set of QoS parameters, wherein, in accordance with the mapping, a first PDU set of a first QoS flow is associated with a first set of QoS parameters and a second PDU set of the first QoS flow is associated with a second set of QoS parameters.

Aspect 97: A method for media session management at a network entity, comprising: obtaining one or more PDUs in association with a PDU session between a first device and a second device; selecting a set of communication parameters for one or more PDUs associated in accordance with a media type (as indicated by a field value, such as a PSI field value) associated with the one or more PDUs; and transmitting the one or more PDUs in accordance with the set of communication parameters.

Aspect 98: The method of aspect 97, further comprising: obtaining the one or more PDUs from one of the first device or the second device or a UPF associated with the network entity; and filtering (e.g., grouping) the one or more PDUs to a QoS flow in accordance with a packet filter that is based at least in part on the PSI field value, wherein the set of communication parameters is selected in association with filtering (e.g., grouping) the one or more PDUs in accordance with the packet filter that is based at least in part on the PSI field value.

Aspect 99: The method of aspect 98, further comprising: determining a QoS flow associated with the one or more PDUs based at least in part on the packet filter, wherein the set of communication parameters is selected in association with determining the QoS flow associated with the one or more PDUs.

Aspect 100: The method of aspect 99, wherein the PSI field value and a set of Internet Protocol parameters jointly define the QoS flow in accordance with the packet filter.

Aspect 101: The method of any of aspects 99 through 100, wherein a respective PSI field value and a respective set of Internet Protocol parameters jointly define a respective QoS flow in accordance with the packet filter.

Aspect 102: The method of any of aspects 98 through 101, wherein the packet filter is an Internet Protocol packet filter or an Ethernet packet filter.

Aspect 103: The method of any of aspects 97 through 102, wherein the set of communication parameters comprise a set of QoS parameters.

Aspect 104: A method for media session management at a network entity, comprising: transmitting, in association with an establishment of a PDU session between a first device and a second device, information associated with a mapping between each protocol PDU set of a plurality of PDU sets and a respective set of communication parameters; obtaining a first PDU set in accordance with the PDU session between the first device and the second device; selecting a first set of communication parameters for the first PDU set associated in accordance with the mapping; and transmitting the first PDU set in accordance with the first set of communication parameters.

Aspect 105: The method of aspect 104, wherein the first PDU set is obtained from one of the first device or the second device or a UPF associated with the network entity.

Aspect 106: The method of any of aspects 104 through 105, further comprising: obtaining a second PDU set in accordance with the PDU session between the first device and the second device; selecting a second set of communication parameters for the second PDU set in accordance with the mapping; and transmitting the second PDU set in accordance with the second set of communication parameters.

Aspect 107: The method of aspect 106, wherein the first PDU set and the second PDU set are associated with a same QoS flow.

Aspect 108: The method of any of aspects 106 through 107, wherein the first PDU set is associated with a first traffic type and the second PDU set is associated with a second traffic type.

Aspect 109: The method of aspect 108, wherein the first traffic type is associated with an I-frame of video data and the second traffic type is associated with a P-frame of video data.

Aspect 110: The method of any of aspects 108 through 109, wherein the first traffic type is associated with telemetry data and the second traffic type is associated with audio data.

Aspect 111: The method of any of aspects 108 through 110, wherein the first traffic type is associated with audio data and the second traffic type is associated with audio metadata data.

Aspect 112: The method of any of aspects 106 through 111, wherein the first set of communication parameters comprise a first set of QoS parameters and the second set of communication parameters comprise a second set of QoS parameters.

Aspect 113: The method of aspect 112, wherein the first set of QoS parameters are associated with a first PDU set delay budget, a first PDU set error rate, and first PDU set integrated handling information and the second set of QoS parameters are associated with a second PDU set delay budget, a second PDU set error rate, and second PDU set integrated handling information.

Aspect 114: The method of aspect 113, wherein the first PDU set delay budget, the first PDU set error rate, and the first PDU set integrated handling information are different than the second PDU set delay budget, the second PDU set error rate, and the second PDU set integrated handling information, respectively, in association with the first PDU set being associated with a first PSI field value that is different than a second PSI field value associated with the second PDU set.

Aspect 115: The method of any of aspects 113 through 114, wherein the first PDU set delay budget, the first PDU set error rate, and the first PDU set integrated handling information are equal to the second PDU set delay budget, the second PDU set error rate, and the second PDU set integrated handling information, respectively, in association with the first PDU set being associated with a first PSI field value that is equal to a second PSI field value associated with the second PDU set.

Aspect 116: A first device for media session management, comprising one or more memories storing processor-executable code, and one or more processors coupled with the one or more memories and individually or collectively operable to execute the code to cause the first device to perform a method of any of aspects 1 through 33.

Aspect 117: A first device for media session management, comprising at least one means for performing a method of any of aspects 1 through 33.

Aspect 118: A non-transitory computer-readable medium storing code for media session management, the code comprising instructions executable by one or more processors to perform a method of any of aspects 1 through 33.

Aspect 119: A first device for media session management, comprising one or more memories storing processor-executable code, and one or more processors coupled with the one or more memories and individually or collectively operable to execute the code to cause the first device to perform a method of any of aspects 34 through 40.

Aspect 120: A first device for media session management, comprising at least one means for performing a method of any of aspects 34 through 40.

Aspect 121: A non-transitory computer-readable medium storing code for media session management, the code comprising instructions executable by one or more processors to perform a method of any of aspects 34 through 40.

Aspect 122: A first device for media session management, comprising one or more memories storing processor-executable code, and one or more processors coupled with the one or more memories and individually or collectively operable to execute the code to cause the first device to perform a method of any of aspects 41 through 51.

Aspect 123: A first device for media session management, comprising at least one means for performing a method of any of aspects 41 through 51.

Aspect 124: A non-transitory computer-readable medium storing code for media session management, the code comprising instructions executable by one or more processors to perform a method of any of aspects 41 through 51.

Aspect 125: A network entity for media session management, comprising one or more memories storing processor-executable code, and one or more processors coupled with the one or more memories and individually or collectively operable to execute the code to cause the network entity to perform a method of any of aspects 52 through 96.

Aspect 126: A network entity for media session management, comprising at least one means for performing a method of any of aspects 52 through 96.

Aspect 127: A non-transitory computer-readable medium storing code for media session management, the code comprising instructions executable by one or more processors to perform a method of any of aspects 52 through 96.

Aspect 128: A network entity for media session management, comprising one or more memories storing processor-executable code, and one or more processors coupled with the one or more memories and individually or collectively operable to execute the code to cause the network entity to perform a method of any of aspects 97 through 103.

Aspect 129: A network entity for media session management, comprising at least one means for performing a method of any of aspects 97 through 103.

Aspect 130: A non-transitory computer-readable medium storing code for media session management, the code comprising instructions executable by one or more processors to perform a method of any of aspects 97 through 103.

Aspect 131: A network entity for media session management, comprising one or more memories storing processor-executable code, and one or more processors coupled with the one or more memories and individually or collectively operable to execute the code to cause the network entity to perform a method of any of aspects 104 through 115.

Aspect 132: A network entity for media session management, comprising at least one means for performing a method of any of aspects 104 through 115.

Aspect 133: A non-transitory computer-readable medium storing code for media session management, the code comprising instructions executable by one or more processors to perform a method of any of aspects 104 through 115.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
transmit, in association with an establishment of a protocol data unit (PDU) session between a first device and a second device, information associated with a mapping between each protocol PDU set of a plurality of PDU sets and a respective set of communication parameters;
obtain a first PDU set and a second PDU set in accordance with the PDU session between the first device and the second device, wherein the first PDU set and the second PDU set are associated with a same quality of service flow;
transmit the first PDU set in accordance with a first set of communication parameters mapped to the first PDU set; and
transmit the second PDU set in accordance with a second set of communication parameters mapped to the second PDU set.

2. The network entity of claim 1, wherein the first PDU set is obtained from one of the first device or the second device or a user plane function associated with the network entity.

3. The network entity of claim 1, wherein:
the first PDU set is associated with a first media type and the second PDU set is associated with a second media type different than the first media type; and
the first set of communication parameters is different than the second set of communication parameters in accordance with the first PDU set being associated with the first media type and the second PDU set being associated with the second media type.

4. The network entity of claim 1, wherein:
the first PDU set is associated with a first PDU set importance (PSI) field value and the second PDU set is associated with a second PSI field value different than the first PSI field value; and
the first set of communication parameters is different than the second set of communication parameters in accordance with the first PDU set being associated with the first PSI field value and the second PDU set being associated with the second PSI field value.

5. The network entity of claim 1, wherein the first set of communication parameters comprises a first set of quality of service parameters and the second set of communication parameters comprises a second set of quality of service parameters.

6. The network entity of claim 5, wherein:
the first set of quality of service parameters is associated with a first PDU set delay budget, a first PDU set error rate, and first PDU set integrated handling information; and
the second set of quality of service parameters is associated with a second PDU set delay budget, a second PDU set error rate, and second PDU set integrated handling information.

7. A first device, comprising:
one or more memories storing processor-executable code; and
one or more processors coupled with the one or more memories and individually or collectively operable to execute the code to cause the first device to:
establish a protocol data unit (PDU) session between the first device and a second device in accordance with an application at the first device;
select a set of communication parameters for one or more PDUs associated with the application in accordance with a media type associated with the one or more PDUs; and
transmit the one or more PDUs in accordance with the set of communication parameters.

8. The first device of claim 7, wherein the one or more processors are individually or collectively further operable to execute the code to cause the first device to:
obtain the one or more PDUs from the application; and
group the one or more PDUs to a quality of service flow in accordance with a packet filter that is based at least in part on the media type,
wherein the set of communication parameters is selected in accordance with the packet filter that is based at least in part on the media type.

9. The first device of claim 8, wherein the media type and a set of Internet Protocol parameters jointly define the quality of service flow in accordance with the packet filter.

10. The first device of claim 8, wherein the packet filter is an Internet Protocol packet filter or an Ethernet packet filter.

11. The first device of claim 7, wherein the set of communication parameters comprise a set of quality of service parameters.

12. The first device of claim 7, wherein the media type associated with the one or more PDUs is based at least in part on a field value associated with the one or more PDUs.

13. The first device of claim 12, wherein the field value is a PDU set importance (PSI) field value.

14. A first device, comprising:
one or more memories storing processor-executable code; and
one or more processors coupled with the one or more memories and individually or collectively operable to execute the code to cause the first device to:
establish a protocol data unit (PDU) session between the first device and a second device in accordance with an application at the first device;
communicate, in association with establishment of the PDU session, a first communication of information associated with an interpretation of a PDU set importance (PSI) field of a PDU header; and
communicate a second communication of one or more PDUs of one or more PDU sets associated with the application in accordance with the interpretation of the PSI field.

15. The first device of claim 14, wherein, to communicate the first communication of the information associated with the interpretation of the PSI field, the one or more processors are individually or collectively operable to execute the code to cause the first device to:
transmit or receive, to or from the second device, a message that comprises the information associated with the interpretation of the PSI field.

16. The first device of claim 14, wherein, to communicate the first communication of the information associated with the interpretation of the PSI field, the one or more processors are individually or collectively operable to execute the code to cause the first device to:
transmit, to a network entity, a first message that comprises a request for the interpretation of the PSI field; and
receive, from the network entity, a second message that comprises an acceptance or a modification of the interpretation of the PSI field requested by the first device,
wherein the second communication of the one or more PDUs is in accordance with the acceptance or the modification of the interpretation of the PSI field by the network entity.

17. The first device of claim 14, wherein, to communicate the first communication of the information associated with the interpretation of the PSI field, the one or more processors are individually or collectively operable to execute the code to cause the first device to:
receive a message that comprises the information associated with the interpretation of the PSI field from a network entity.

18. The first device of claim 14, wherein the interpretation of the PSI field indicates a mapping that associates each PSI field value of a plurality of PSI field values to a respective media type.

19. The first device of claim 14, wherein the interpretation of the PSI field indicates a mapping that:
associates two or more PSI field values of a plurality of PSI field values as corresponding to PDU sets having a dependency relationship; and
associates each PSI field value of the plurality of PSI field values to a respective set of communication parameters.

20. The first device of claim 14, wherein the one or more processors are individually or collectively further operable to execute the code to cause the first device to:
receive, in association with the establishment of the PDU session, second information associated with a mapping between each PDU set of a plurality of PDU sets and a respective set of quality of service parameters, and
wherein each PDU set of the plurality of PDU sets is associated with a same quality of service flow,
wherein, in accordance with the mapping, a first PDU set of the same quality of service flow is associated with a first set of quality of service parameters and a second PDU set of the same quality of service flow is associated with a second set of quality of service parameters different than the first set of quality of service parameters.
